(19) United States
(12) Patent Application Publication
(10) Pub. No.: US 2023/0404712 A1
(43) Pub. Date: Dec. 21, 2023

(54) PRE-ACTIVATED ARCH EXPANDER DESIGN METHOD, MANUFACTURING METHOD AND SYSTEM AND A PRE-ACTIVATED ARCH EXPANDER

(71) Applicant: LM TECHNOLOGY (BEIJING) CO. , LTD., Beijing (CN)

(72) Inventors: Xu ZHENG, Beijing (CN); Jingchao SUN, Beijing (CN)

(21) Appl. No.: 18/459,991

(22) Filed: Sep. 1, 2023

Related U.S. Application Data
(63) Continuation of application No. PCT/CN2023/080569, filed on Mar. 9, 2023.

(30) Foreign Application Priority Data
Mar. 11, 2022 (CN) 202210242424.3
Mar. 11, 2022 (CN) 202210243092.0

(51) Int. Cl. A61C 7/00; A61C 7/10; G06F 30/10; B21F 3/08

(52) U.S. Cl. CPC A61C 7/002; A61C 7/10; G06F 30/10; B21F 3/08

(57) ABSTRACT

The application provides methods for designing a pre-activated arch expander, methods and systems for manufacturing a pre-activated arch expander, and pre-activated arch expanders. The method for designing a pre-activated arch expander includes: determining a target arch expansion parameter based on a digital model of an initial dental jaw in an initial dental arch form; determining a digital model of a target dental jaw in a target dental arch form based on the digital model of the initial dental jaw and the target arch expansion parameter; and designing a digital model of a pre-activated arch expander based on the target arch expansion parameter and the digital model of the target dental jaw.

### RELATED APPLICATIONS

This application is a continuation application of International Patent Application No. PCT/CN2023/080569, filed on Mar. 9, 2023, which claims priority to Chinese Patent Application Nos. 202210243092.0 and 202210242424.3, both filed on Mar. 11, 2022, the contents of all of which are incorporated herein by reference in their entirety.

### TECHNICAL FIELD

The present disclosure relates to the technical field of orthodontics and, in particular, to methods for designing a pre-activated arch expander, methods for manufacturing a pre-activated arch expander, systems for manufacturing a pre-activated arch expander, and pre-activated arch expanders.

### BACKGROUND

Arch expanders are commonly used orthopedic appliances in the field of orthodontics to correct narrow arches and crowded dentition and adjust the width of the upper and lower dental arches, and so on.

An arch expander generally includes a retaining part that fixes an orthopedic appliance to teeth and an arch expansion part that is used to expand an arch. The elastic recovery force generated by the deformation of the arch expansion part under a force is applied to teeth and transmitted to an alveolar bone, which can cause an increase in the widths of the maxillary and mandibular arches and the alveolar bone arch, thus achieving the effect of arch expansion.

When being made, the existing arch expander is generally made by a technician on an initial model before treatment according to the requirements of an orthodontist's design order. The arch expansion part can be made by bending arch wires of different diameters and properties into expanding springs of different shapes, or a spiral expander can be used as the arch expansion part. The retaining part can be made into a fixed or movable arch expander with bands, clasps, etc. When using an arch expander in clinical practice, the orthodontist needs to adjust and activate the arch expansion part by himself/herself. This method of operation relies heavily on the physician's experience and clinical practice, and the actual amount of an orthodontic force generated and the amount of arch expansion that can be achieved after activation cannot be accurately estimated and may differ significantly from the expected orthodontic treatment scheme. Therefore, it is necessary to constantly monitor the therapeutic effect and make adjustments repeatedly during the entire arch expansion process, which is unpredictable and difficult for beginners to master. In addition, for children who require arch expansion, repeated removal of the orthodontic appliances in the mouth can cause pain and discomfort, resulting in poor cooperation.

Due to the above problems in existing arch expanders, there is a need for a method and a system that can manufacture an arch expander in a pre-activated state according to predetermined target arch expansion parameters (e.g., arch expansion amount, arch expansion force, etc.).

### SUMMARY

To solve the above-mentioned problems in the conventional technique, one aspect of the present disclosure provides a method for designing a pre-activated arch expander including a retaining band and an arch expansion part, where the method includes the following steps.

S100: determining a target arch expansion parameter according to a digital model of an initial dental jaw in an initial dental arch form, where the target arch expansion parameter includes a target arch expansion amount and a target arch expansion force.

S200: determining a digital model of a target dental jaw in a target dental arch form according to the digital model of the initial dental jaw and the target arch expansion parameter.

S300: designing a digital model of a pre-activated arch expander based on the target arch expansion parameter and the digital model of the target dental jaw.

In some exemplary embodiments, the target arch expansion amount includes one or more of following parameters corresponding to an adjustment of a jaw from the initial dental arch form to the target dental arch form: the amount of dental arch expansion of the whole of an upper jaw, the amount of dental arch expansion of one side of the upper jaw, the amount of dental arch expansion of the anterior region of the upper jaw, the amount of the dental arch expansion of a posterior region of the upper jaw, the amount of dental arch expansion of the whole of a lower jaw, the amount of dental arch expansion of one side of the lower jaw, the amount of dental arch expansion of the anterior region of the lower jaw, and the amount of the dental arch expansion of a posterior region of the lower jaw.

In some exemplary embodiments, the target arch expansion amount is determined by the difference between the widths of the initial dental arch form and the target dental arch forma at a corresponding position.

In some exemplary embodiments, the difference between the widths of the initial dental arch form and the target dental arch forma at a corresponding position is determined based on the measurement of the digital model of the initial dental jaw and analysis of the arch form of the digital model of the initial dental jaw.

In some exemplary embodiments, the target arch expansion force includes the value and the direction of an arch expansion force acting on each tooth of a jaw for adjusting the jaw from the initial dental arch form to the target dental arch form.

In some exemplary embodiments, the method for designing a pre-activated arch expander further includes steps of adjusting at least one of the target arch expansion amount or the target arch expansion force according to the loss of an arch expansion force.

In some exemplary embodiments, the method for manufacturing a pre-activated arch expander further includes a step of adjusting the digital model of the target dental jaw according to the loss of the arch expansion force.

In some exemplary embodiments, step S300 further includes the following steps.

S310: determining a target geometric parameter of the pre-activated arch expander based on the digital model of the target dental jaw;

S320: searching whether there is a digital model of a preset arch expander that meets a matching requirement from a database according to the target arch expansion parameter and the target geometric parameter; if the result of the searching is true: exporting the result of the searching as the digital model of the pre-activated arch expander, exporting a material parameter of the digital model of the pre-activated arch expander at the same time, and ending the step of designing a digital model of a pre-activated arch expander; if the result of the searching is false: perform the step S330.

S330: designing the digital model of the pre-activated arch expander by using a finite element method according to the target geometric parameter and the target arch expansion parameter, and obtaining the digital model of the pre-activated arch expander that meets an arch expansion constraint condition and a material parameter of the digital model of the pre-activated arch expander.

In some exemplary embodiments, wherein the target geometric parameter includes one or more of the following parameters: number, shape, and fixed position of one or more retaining bands; the number of one or more spring coils contained in the arch expansion part; position, diameter, and angle of each spring coil; curvature of an arch wire between adjacent spring coils; and bending angle, length and curvature of a lingual arm contained in the arch expansion part.

In some exemplary embodiments, the material parameter includes one or more of the following parameters: composition and performance of a material used for manufacturing the arch expansion part; and shape and dimension of a cross-section of an arch wire used for manufacturing the arch expansion part.

In some exemplary embodiments, the material parameter includes a parameter representing that the performance of the material varies with temperature.

In some exemplary embodiments, the matching requirement in step S320 includes: the deviation between a geometric parameter of the digital model of the preset arch expander and the target geometric parameter is less than a preset first threshold, and the deviation between an actual arch expansion parameter of the digital model of the preset arch expander and the target arch expansion parameter is less than a preset second threshold.

In some exemplary embodiments, step S330 includes the following steps.

S331: generating a finite element model of the initial dental jaw according to the digital model of the initial dental jaw.

S332: generating a finite element model of an initial intermediate arch expander according to the target geometric parameter and the target arch expansion parameter, and setting an initial value for a material parameter of the initial intermediate arch expander.

S333: performing a finite element calculation on the effect of the finite element model of the intermediate arch expander acting on the finite element model of the initial dental jaw, wherein a result of the finite element calculation includes an actual arch expansion parameter of the intermediate arch expander and a situation about the change of the form of the finite element model of the initial dental jaw.

S334: optimizing the geometric parameter and the material parameter of the finite element model of the intermediate arch expander according to the result of the calculation and repeating the calculation until the result of the calculation meets a preset judgment condition and the arch expansion constraint condition, and exporting the finite element model of the intermediate arch expander as the digital model of the pre-activated arch expander and also exporting a material parameter of the digital model of the pre-activated arch expander.

In some exemplary embodiments, the arch expansion constraint condition includes one or more of the following conditions: a constraint condition on a contact position between the finite element model of the intermediate arch expander and the finite element model of the initial dental jaw; a biomechanical constraint condition on the displacement of the finite element model of the initial dental jaw under the action of the arch expansion force; and a restriction condition on a tooth root movement of the finite element model of the initial dental jaw

In some exemplary embodiments, step S330, after step S334, further includes the following step.

S335: adding a digital model of the optimized pre-activated arch expander to the database as a digital model of a new preset arch expander, and storing an actual arch expansion parameter, a geometric parameter, and a material parameter corresponding to the digital model of the new preset arch expander in the database.

Another aspect of the present disclosure provides a method for manufacturing a pre-activated arch expander, which includes the following steps.

Step 1: designing a digital model of a pre-activated arch expander using the above-mentioned method for designing a pre-activated arch expander.

Step 2: manufacturing a retaining band and an arch expansion part using the digital model of the pre-activated arch expander and its corresponding material parameter;

Step 3: assembling the retaining band and the arch expansion part on a physical model of a target dental jaw to obtain a pre-activated arch expander matching a target dental arch form, wherein the physical model of the target dental jaw is manufactured from a digital model of the target dental jaw.

In some exemplary embodiments, Step 3 is followed by the following step.

Step 4: maintaining the pre-activated arch expander in a form that matches an initial dental arch form.

In some exemplary embodiments, the pre-activated arch expander is maintained in a form that matches an initial dental arch form using the following steps: applying a deforming force to the pre-activated arch expander and mounting the pre-activated arch expander to a physical model of an initial dental jaw, where the physical model of the initial dental jaw is generated based on a digital model of the initial dental jaw; and maintaining the pre-activated arch expander in a form that matches the initial dental arch form using a removable transfer template.

In some exemplary embodiments, a manufacturing material of the pre-activated arch expander is a material having a shape memory effect and an oral temperature of a human is within a transformation temperature range of the manufacturing material, and an ambient temperature condition for the manufacture and the assembly of the pre-activated arch expander is within the transformation temperature range of the manufacturing material.

In some exemplary embodiments, the pre-activated arch expander is maintained in a form that matches an initial dental arch form using the following steps: under the ambient temperature condition outside the transformation temperature range of the manufacturing material, mounting the pre-activated arch expander to a physical model of an initial dental jaw to maintain the pre-activated arch expander in a form that matches the initial dental arch form, wherein the physical model of the initial dental jaw is generated based on a digital model of the initial dental jaw.

Yet another aspect of the present disclosure provides a pre-activated arch expander including a retaining band and an arch expansion part. The pre-activated arch expander is manufactured by the above-mentioned method for manufacturing a pre-activated arch expander.

Yet another aspect of the present disclosure provides a system for manufacturing a pre-activated arch expander, which includes: a design unit configured to design a digital model of a pre-activated arch expander using the above-mentioned method for designing a pre-activated arch expander; a production unit configured to manufacture a retaining band and an arch expansion part using the digital model of the pre-activated arch expander and its corresponding material parameter; and an assembly unit configured to assemble the retaining band and the arch expansion part on a physical model of a target dental jaw to obtain the pre-activated arch expander matching a target dental arch form, wherein the physical model of the target dental jaw is manufactured based on the digital model of the target dental jaw.

Further aspects of the present disclosure provide a method for manufacturing a pre-activated arch expander, a pre-activated arch expander manufactured using this method, and a system for manufacturing a pre-activated arch expander.

In some exemplary embodiments, a method for manufacturing a pre-activated arch expander includes the following steps.

A100: determining a target arch expansion amount according to a digital model of an initial dental jaw in an initial dental arch form.

A200: determining a target arch expansion force according to the initial dental arch form and the target arch expansion amount.

A300: determining a digital model of a target dental jaw in a target dental arch form according to the digital model of the initial dental jaw and a target arch expansion parameter.

A400: determining a geometric parameter and a material parameter of a pre-activated arch expander according to the digital model of the target dental jaw and the target arch expansion force.

A500: selecting a manufacturing material according to the material parameter, manufacturing the pre-activated arch expander on a physical model of the target dental jaw according to the geometric parameter, wherein the physical model of the target dental jaw is generated based on the digital model of the target dental jaw.

In some exemplary embodiments, the target arch expansion force includes the range and the direction of the arch expansion force acting on each tooth of a jaw for adjusting the jaw from the initial dental arch form to the target dental arch form.

In some exemplary embodiments, the target arch expansion is determined based on the initial dental arch form and the target arch expansion amount according to the principle of oral orthodontic mechanics.

In some exemplary embodiments, the target arch expansion force is determined by retrieving a similar historical case from a database to obtain a corresponding treatment regimen, based on the initial dental arch form and the target arch expansion amount.

In some exemplary embodiments, the target arch expansion force is determined based on a relationship between an arch expansion amount and an arch expansion force, wherein the relationship is obtained statistically from an experimental measurement and/or a clinical treatment result.

In some exemplary embodiments, the method further includes a step of adjusting the target arch expansion amount and/or the target arch expansion force according to one or more of a patient's age, developmental status, and type of malocclusion.

In some exemplary embodiments, the method further includes a step of adjusting the target arch expansion amount and/or the target arch expansion force according to the loss of an arch expansion force.

In some exemplary embodiments, the method further includes a step of adjusting the digital model of the target dental jaw according to the loss of an arch expansion force.

In some exemplary embodiments, step A500 is followed by step A600: maintaining a pre-activated arch expander in a form that matches an initial dental arch form.

In some exemplary embodiments, a pre-activated arch expander includes a retaining band and an arch expansion part and is manufactured using the above-mentioned method for manufacturing a pre-activated arch expander.

In some exemplary embodiments, a system for manufacturing a pre-activated arch expander includes: a pre-processing unit configured to obtain information about a jaw in an initial dental arch form and generate a digital model of an initial dental jaw; and a manufacturing unit configured to manufacture a pre-activated arch expander using the above-mentioned method for manufacturing a pre-activated arch expander.

A method for designing a pre-activated arch expander, a method for manufacturing a pre-activated arch expander, a system for manufacturing a pre-activated arch expander, and a pre-activated arch expander provided by exemplary embodiments of the present disclosure have at least the following beneficial effects.

(1) In the technical solution of the present disclosure, an arch expansion amount parameter is determined based on the difference between the width of a part of a target dental arch form and the width of a corresponding part of an initial dental arch form and generates a target digital model of a dental jaw, this model is used as the design basis for the overall geometry of the pre-activated arch expander, and a target arch expansion force to be applied to the dental jaw to be orthodontically treated and the material parameters of the required manufacturing material are further determined based on the target arch expansion amount. Through the above steps, the geometry of the arch expander is in a pre-activated state matching the target dental arch form and the actual arch expansion force applied to the dental jaw can be within a preset range of the arch expansion force, thus effectively improving the situation that the existing arch expander needs to be repeatedly removed from the mouth for shape adjustment during use, and greatly improving the use experience.

(2) In the technical solution of the present disclosure, the loss of the arch expansion force due to the widening of the arch during expansion is taken into consideration. By compensating the target arch expansion amount or the target arch expansion force and adjusting the target dental jaw model, the actual arch expansion effect of the pre-activated arch expander is more in line with the expected arch expansion effect.

(3) Patients with similar age and/or similar arch characteristics tend to have greater similarity in the key parameters of their orthodontic treatment schemes, such as arch expansion amount and arch expansion force, and the geometric characteristics and mechanical properties of the arch expanders designed, and manufactured for these patients are also relatively similar. Therefore, the orthodontic treatment schemes for previous patients and corresponding arch expanders can often provide useful references for the current orthodontic treatment schemes and the design of the arch expanders, while in conventional techniques the manufacture of arch expanders is generally carried out directly, i.e., without using the previously designed arch expanders to improve the design and manufacturing efficiency. By retrieving the preset arch expander digital models stored for historical cases in the database, the models matching the orthodontic treatment target can be retrieved quickly, thus greatly reducing the time for designing and manufacturing the pre-activated arch expanders.

(4) The finite element method is used to simulate the actual arch expansion effect of the arch expander and optimize the finite element model of the arch expander according to the deviation from the design target, thus improving the error of the design based on artificial experience in the conventional technique and effectively enhancing the arch expansion effect of the pre-activated arch expander.

(5) In exemplary embodiments of the present disclosure, the method further includes adjusting the shape of a pre-activated arch expander to an inactivated state that matches an initial arch form and locking it using a transferring template; or using a material with a memory effect to manufacture the arch expansion part and maintaining it in the inactivated state by means of temperature control. The arch expanders in the inactivated state manufactured by the above method are more convenient during clinical installation and use, and can greatly improve the treatment efficiency and comfort in using the product.

### BRIEF DESCRIPTION OF THE DRAWINGS

FIG. 1 is a schematic diagram of an arch expander according to the conventional technique;

FIG. 2 is a flow chart of a pre-activated arch expander manufacturing method according to exemplary embodiments of the present disclosure;

FIG. 3 is a schematic diagram of a digital model of an initial dental jaw according to exemplary embodiments of the present disclosure;

FIG. 4 is a schematic diagram of determining a target arch curve, an initial arch curve, and a comparison of the two according to exemplary embodiments of the present disclosure;

FIG. 5 is a schematic diagram of generating a digital model of a target dental jaw according to exemplary embodiments of the present disclosure;

FIG. 6 shows an implementation flow of step S300 according to exemplary embodiments of the present disclosure;

FIG. 7 is a schematic diagram of a pre-activated arch expander matching a target dental arch form according to exemplary embodiments of the present disclosure;

FIG. 8 shows an implementation flow of step S320 according to exemplary embodiments of the present disclosure;

FIG. 9 shows an implementation flow of step S330 according to exemplary embodiments of the present disclosure;

FIGS. 10A to 10C illustrate the form changes (strain) produced by an initial dental jaw finite element model under the action of arch expansion during finite element calculations according to exemplary embodiments of the present disclosure;

FIG. 11 is a flow chart of a method for manufacturing a pre-activated arch expander according to exemplary embodiments of the present disclosure;

FIG. 12 is a schematic diagram of a pre-activated arch expander locked in an inactivated state by a transferring template according to exemplary embodiments of the present disclosure;

FIG. 13 is a block diagram of the system structure of a system for manufacturing a pre-activated arch expander according to exemplary embodiments of the present disclosure;

FIG. 14 is a flow chart of a method for manufacturing a pre-activated arch expander according to exemplary embodiments of the present disclosure; and

FIG. 15 is a block diagram of the system structure of a system for manufacturing a pre-activated arch expander according to exemplary embodiments of the present disclosure.

### DETAILED DESCRIPTION

Hereinafter, the present disclosure will be described further with reference to the exemplary embodiments and with reference to the accompanying drawings. The illustrative embodiments referred to in the description and accompanying drawings are for illustrative purposes only and are not intended to limit the scope of protection of this application. It will be understood by those skilled in the art that many other embodiments can also be used, and that various changes can be made to the described embodiments without departing from the subject matter and scope of protection of the present disclosure. It should be understood that the aspects of this disclosure described and illustrated herein can be arranged, replaced, combined, separated, and designed in many different configurations, all of which are included in this disclosure.

In addition, the various components on the drawing are enlarged or reduced for the convenience of understanding, but this practice is not intended to limit the scope of protection of the present disclosure. In the description of the embodiments of the present disclosure, the orientation or positional relationship indicated by the terms “upper,” “lower,” “inner,” “outer,” etc., is based on the orientation or positional relationship shown in the figures, or the orientation or positional relationship conventionally placed when the product is used, is merely for the convenience of describing the present disclosure and the simplified description, and is not intended to indicate or imply that the indicated device or element must have a particular orientation, constructed and operated in a particular orientation, and therefore not to be construed as a limitation of the present disclosure.

In addition to this, the order of the boxes given herein for flowcharts, functional descriptions, and method claims should not be limited to various embodiments that are implemented in the same order to perform the described functions, unless explicitly stated in the context.

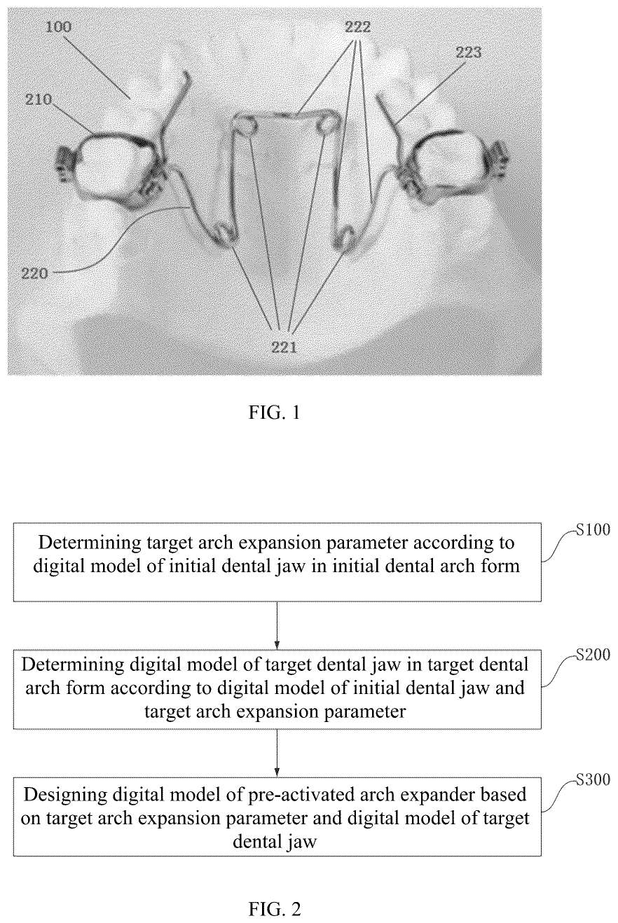

In order to better illustrate embodiments of this disclosure, we first provide a brief description of the designing and manufacturing process of existing arch expanders. FIG. 1 shows an example of a conventional arch expander mounted on a dental model 100. As shown in FIG. 1, the arch expander generally includes a retaining band 210 and an arch expansion part 220. The retaining band is used to securely fix the arch expander to the teeth, and the arch expansion part 220 includes a plurality of spring coils 221, a lingual arm 223, and a plurality of arch wires 222 for connecting the spring coils and the lingual arm. After the above-mentioned arch expander is mounted to an upper or lower jaw, the arch expansion part 220 deforms and generates an arch expansion force on the teeth and alveolar bone under the action of a rebound force to achieve an effect of arch expansion.

The design and manufacture of existing arch expanders rely on the experience of orthodontists and technicians, who need to estimate parameters such as the arch expansion amount and the arch expansion force based on the patient's maxillary and/or mandibular arch in clinical practice, and then activate the arch expansion part themselves or teach the patient and parents to apply the force themselves. The above designing and manufacturing methods of existing arch expanders have at least the following problems.

(1) In the case where no target dental arch form or dental model in a target dental arch form can be used as a reference basis, the manufacture of an arch expander on an initial jaw model can only rely on the experience of orthodontists and technicians, and the clinical application of the arch expander relies only on the experience of orthodontists to activate it, and it is difficult to determine whether the magnitude and the direction of the orthodontic force actually generated after activation and the achievable arch expansion effect are in accordance with the expected orthodontic treatment scheme, making the effectiveness and the safety of the arch expander in clinical use difficult to predict, and thus close monitoring by orthodontists and good cooperation from patients are required.

(2) Patients with similar age and/or similar arch characteristics tend to have greater similarity in the arch expansion parameters of their orthodontic treatment schemes, such as arch expansion amount and arch expansion force, and the geometric characteristics of the arch expanders designed and manufactured for these patients and the properties of manufacturing materials selected for arch expanders are also relatively similar. Therefore, the orthodontic treatment schemes for previous patients and corresponding arch expanders can often provide useful references for the current orthodontic treatment schemes and the design of the arch expanders, while in conventional techniques the manufacture of arch expanders is generally carried out directly, i.e., without using the previously designed arch expanders to improve the design and manufacturing efficiency.

(3) Since the arch expander needs to be activated and applied with a force during the installation process before it is installed into a patient's mouth, the arch expander is likely to have structural deformation in the activation process, resulting in poor matching with the patient's jaws and even producing undesired forces, which also increases the unpredictability of the efficacy as well as the risk. It is because of the poor predictability and the difficulty in estimating the risk that in the current clinical use of arch expanders, applying a force is generally very cautious and requires several follow-up visits and repeated installation and removal of the orthodontic appliances, or requires patients to learn applying a force on their own, which is not very convenient in use. This is why many orthodontists are willing to choose a movable arch expander, which reduces the orthodontist's chairside time and risk. However, the movable arch expander is large, ineffective, requires more patient cooperation, and increases the patient's discomfort and course of treatment, especially for children who require arch expansion, which causes a lot of inconvenience in terms of clinical outcomes and patient management.

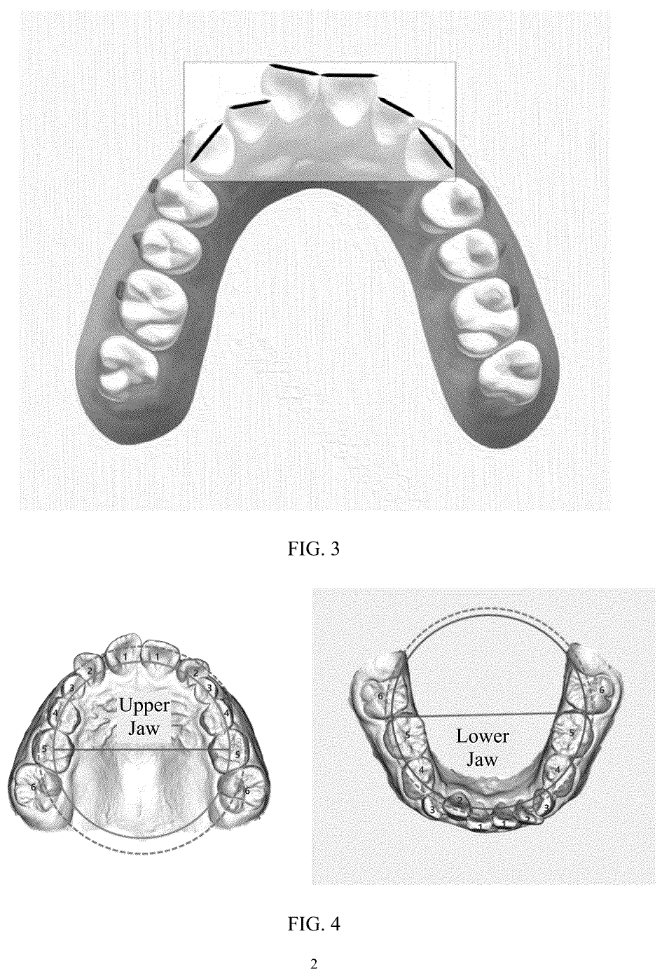

To solve the above-mentioned problems in the conventional technique, the present disclosure provides a method for designing a pre-activated arch expander through some exemplary embodiments, where the pre-activated arch expander includes a retaining band and an arch expansion part, and FIG. 2 illustrates a flow chart of this method for designing a pre-activated arch expander. As shown in FIG. 2, this method includes the following steps.

S100: determining a target arch expansion parameter according to a digital model of an initial dental jaw in an initial dental arch form, where the target arch expansion parameter includes a target arch expansion amount and a target arch expansion force;

S200: determining a digital model of a target dental jaw in a target dental arch form according to the digital model of the initial dental jaw and the target arch expansion parameter;

S300: designing a digital model of a pre-activated arch expander based on the target arch expansion parameter and the digital model of the target dental jaw.

The above steps S100 to S300 will be described in detail below in combination with the accompanying drawings and embodiments.

Step S100 is the process of determining a target arch expansion parameter needed to expand a jaw based on a digital model of an initial dental jaw. For example, the target arch expansion parameter includes a target arch expansion amount and a target arch expansion force.

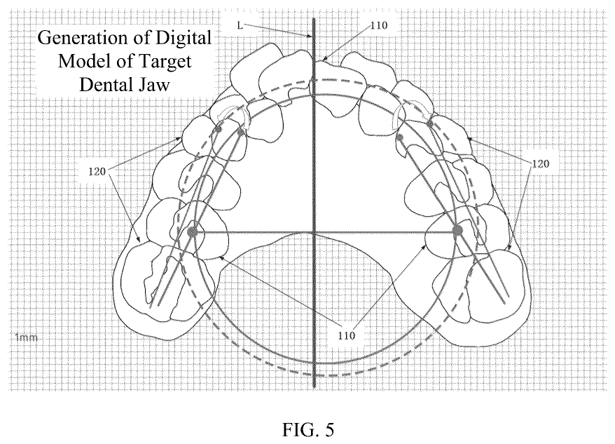

FIG. 3 is a schematic diagram of a digital model of an initial dental jaw according to exemplary embodiments of the present disclosure. The digital model of the initial dental jaw can be obtained by a variety of methods. For example, in some exemplary embodiments of the present disclosure, a digital 3D model of the teeth, periodontal tissues and alveolar bone, and other parts can be obtained by optical scanning, X-ray/ultrasound imaging, CT scanning or MM, and digital 3D model of each of the aforementioned tissue parts can be further processed by operations such as denoising, cavity filling, and registration to obtain the digital model of the initial dental jaw and the above steps for establishing the digital model of the initial dental jaw are known to those skilled in the art.

It should be noted that the digital model of the initial dental jaw may contain only information on the geometric characteristics of the initial dental jaw. For example, in some exemplary embodiments of the present disclosure, the digital model of the initial dental jaw may include a triangular patch without thickness information; in addition, the digital model of the initial dental jaw may also be a finite element model containing information of physiological, histological, and biomechanical characteristics of various parts. For example, in some other embodiments of the present disclosure, the digital 3D model of each part mentioned above can be filled to make it solid, and the finite element mesh can be divided according to the preset rules to form finite element cells of different tissue parts such as teeth, periodontal tissue, alveolar bone, etc. Finally, the material parameters of the finite element cells of each part mentioned above can be set, where the material parameters can include parameters such as elastic modulus and Poisson's ratio reflecting the biomechanical characteristics of the tissues. Finally, a finite element model of the initial dental jaw is obtained. The steps described above for establishing the finite element model of the initial dental jaw are known to those skilled in the art.

The digital model of the initial dental jaw generated after the above steps represent the state of the jaws before orthodontic treatment. For patients with narrow arches, their initial dental arch form is usually cusp-rounded. In addition, there may be some abnormal arch forms, for example, the six teeth in the anterior region in FIG. 3 have significant arch crowding and misalignment (the solid black line in the figure is the line connecting the two endpoints of each tooth in the distal and mesial directions). The orthodontic treatment process of performing arch expansion over the jaws is the gradual adjustment of the jaws from an abnormal initial dental arch form to a target dental arch form by wearing an arch expander.

In some exemplary embodiments of the present disclosure, the information representing an initial dental arch form can be obtained by measuring a digital model of an initial dental jaw, and further information representing a target dental arch form can be obtained by arch analysis. After obtaining the above information, the target arch expansion amount can be determined based on the difference between the widths of the corresponding positions of the initial and target dental arch forms.

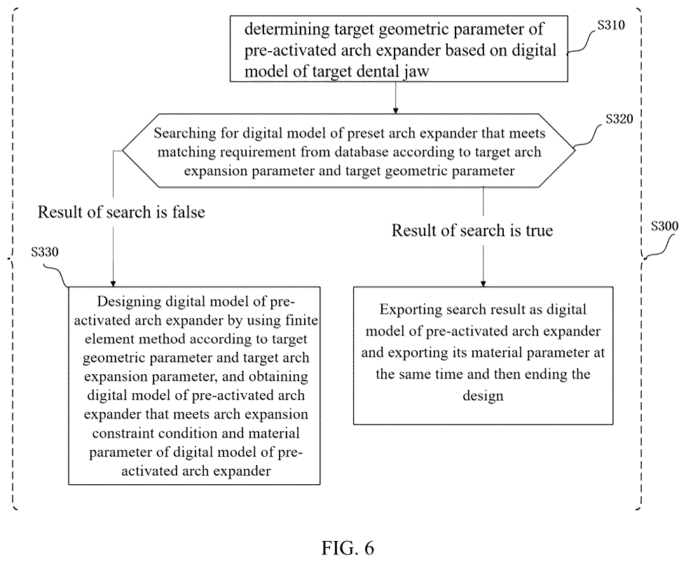

In the field of orthodontic technology, the arch form is often described qualitatively and quantitatively using the arch curve, which reflects an approximate arch-shaped curve formed by fitting characteristic points of individual teeth in the dentition. Clearly, the maxilla and mandible have their arch curves, and depending on the form of the arch, the arch curves can be divided into an initial arch curve (or existing arch curve) and a target arch curve (or ideal arch curve). The target arch expansion amount can be easily and precisely determined based on the difference between the widths of the corresponding parts of the initial and target arch curves. The detailed description of determining the initial arch curve and the target arch curve by measuring the digital model of the initial dental jaw, and determining the target arch expansion amount based on the difference between the widths of the corresponding parts of the initial arch curve and the target arch curve is illustrated in detail below with reference to FIG. 4.

Based on the size of the teeth, each patient has an ideal oval-shaped Bonwill arch curve for the upper and lower jaws. The existing Bonwill arch curve of the patient is compared with the ideal Bonwill arch curve, and the difference in the widths of the corresponding parts is the arch expansion amount required to perform arch expansion.

The most buccal contact points on the adjacent surfaces of teeth #5 and #6 on the left and right sides of the lower teeth are selected, and a circle can be made with these points as ends of the diameter. When the arch form is the ideal oval shape, the cusps and incisive edges of left tooth #4 to right tooth #4 of the lower jaw should fall on the curve of the circle according to the Bonwill arch curve principle. Correspondingly, the occlusal contact points of the left tooth #4 to the right tooth #4 of the lower jaw with respect to the upper arch are also distributed on the curve of the circle of equal size, i.e., the circle is made by taking the line connecting the central pits of the occlusal surfaces of a left tooth #5 and a right tooth #5 of the upper jaw (the point of the central pit of the occlusal surface of the tooth #5 on the upper jaw corresponds to the most buccal point of the contact points of the adjacent surfaces of teeth #5 and #6 on the lower jaw) as its diameter, and this circle overlaps exactly with the circle of the lower arch of the aforementioned ideal form.

When the arch width is decreased, the diameter of the circle is reduced compared with an ideal arch form when the circle is drawn according to the above rule, and the arch curve formed from the left tooth #4 to the right tooth #4 will deviate from the arc, so that the arch appears cusp-rounded, or the arch curve remains basically on the arc, but the dentition is crowded. In this case, it is necessary to expand the arch to a desired width in order to obtain clearance, restore the arch form by inwardly closing the anterior part of the cusp-rounded arch curve, or extend the arch curve to align the teeth.

For example, in some exemplary embodiments of the present disclosure, as shown in FIG. 4, a target arch expansion amount may be determined by the following steps.

(1) Determining a target arch curve by measuring the width of the widest position in the mesial and distal direction of each of the crowns of 10 teeth (i.e., from left tooth #5 all the way to right tooth #5) of the lower jaw of an initial dental model; summing up all the widths to obtain an arc length of a semicircle that the ideal Bonwill arch curve (i.e., the target arch curve) of the initial jaw model should have; then obtaining a radius of the semicircle; and drawing a circle according to the radius of the ideal Bonwill arch curve obtained from the above calculation by taking the midpoint of the line connecting the most buccal contact points on the adjacent surfaces of teeth #5 and #6 on the left and right sides of the lower jaw as the center of the circle, so as to simply obtain an arch curve (i.e., the target arch curve, shown as a dashed circle in FIG. 4) corresponding to an ideal arch form.

(2) Determining an initial arch curve corresponding to each of the upper jaw (i.e., maxilla) and the lower jaw (i.e., mandible) by: drawing a circle by using a middle point of a line connecting the most buccal contact points on the adjacent surfaces of teeth #5 and #6 on the left and right sides of the lower jaw of the initial digital model as the center of the circle and using this line as the diameter of the circle, which is the initial arch curve of the lower jaw; drawing a circle by using a middle point of a line connecting midpoints of the occlusal surfaces of the left and right teeth #5 of the upper jaw as the center of the circle and using this line as the diameter of the circle, which is the initial arch curve of the upper jaw (the initial arch curves of the upper and lower jaws are shown as solid lines in FIG. 4). During the arch analysis, as shown in FIG. 4, the target arch curve can also be transferred to the corresponding position in the upper jaw to facilitate further comparative measurements.

(3) Determining the target arch expansion amount for the upper and lower jaws, respectively by obtaining the target arch expansion amount for the upper jaw (or lower jaw) by calculating the difference between the widths of the target arch curve and the initial arch curve of the upper jaw (or lower jaw) at the corresponding parts.

In some exemplary embodiments of the present disclosure, the width of the target arch curve minus the width of the initial arch curve of the upper jaw (or lower jaw) can be directly used as the overall arch expansion amount of the upper jaw (or lower jaw); in some exemplary embodiments of the present disclosure, the width of the target arch curve minus the width of the initial arch curve of the upper jaw (or lower jaw) can also be used as the arch expansion amount of the posterior part of the upper jaw (or lower jaw), i.e. the posterior region. Based on this, the arch expansion amount of the anterior part of the upper jaw (or lower jaw), i.e., the anterior region, or the unilateral arch expansion amount of the upper jaw (or lower jaw) can be adjusted according to the actual situation of the patient.

By using the above-mentioned methods to express the target arch expansion amount, a more accurate arch expansion target can be set for a specific arch form of the patient, which provides a more accurate reference for the subsequent determination of the arch expansion force and the manufacture of the arch expander.

After determining the target arch expansion amount by the above steps, the target arch expansion force needs to be further determined. The target arch expansion force represents the parameters of the orthodontic force that needs to be applied to the teeth to adjust the jaw from an initial dental arch form to a target dental arch form. For example, in some exemplary embodiments of the present disclosure, the range of the values and the orientation of the arch expansion force applied to each tooth by the one-time arch expansion is included.

In some exemplary embodiments of the present disclosure, the value and direction of the target arch expansion force applied to each tooth may have definite values; in some exemplary embodiments of the present disclosure, the target arch expansion force applied to each tooth may also be expressed as a set of ranges of values for the magnitude and the orientation of the force. That is to say, the arch expansion force between the upper and lower limits of the range may all achieve the desired target arch expansion amount.

In the technical solutions of the present disclosure, the target arch expansion force can be determined in various ways. For example, in some exemplary embodiments of the present disclosure, the target arch expansion force can be determined based on an initial dental arch form and the target arch expansion amount according to the principle of oral orthodontic mechanics.

In some exemplary embodiments of the present disclosure, to determine the target arch expansion force, historical cases with similarities to the patient's age, jaw condition, arch form, etc. may also be retrieved from a database based on the initial arch from and target arch expansion amount, and information on the arch expansion amount achieved and the corresponding expansion force applied may be obtained from the treatment plan recorded in the above-mentioned historical cases and used as a reference.

In some exemplary embodiments of the present disclosure, the target arch expansion force can also be determined based on the relationship between the arch expansion amount and the arch expansion force obtained using experimental measurements and/or statistics of the results of clinical treatment. For example, the relationship between the arch expansion amount and the arch expansion force can be obtained based on statistics of the arch expansion force applied by the arch expander on the patient's jaw in a large number of clinical treatment cases and the arch expansion effect actually achieved after the arch expansion operation, or statistics of the arch expansion force exerted by the arch expander and situations of formal changes that caused in a whole physical model of the jaw (which is created to simulate alveolar bone to periodontal tissue to teeth) by means of experimental measurements using a thin film pressure sensor. (it should be noted that the above experimental measurements are not limited to actual physical measurements, the technician can also transfer the above experimental measurements to a simulated experimental environment, for example, by using finite element calculations to obtain simulation results of the arch expansion force exerted by the digital model of the arch expander on the digital model of the jaw(s) and the resulting arch expansion effect) The relationship between the arch expansion amount and the arch expansion force can be expressed in various ways, for example, the relationship curve between the arch expansion amount and the arch expansion force expressed in the form of a curve on a two-dimensional plane, or the relationship between the arch expansion amount and the arch expansion force as a function generated, for example, by a polynomial fit. Once the above relationship between the arch expansion amount and the arch expansion force has been obtained, it is easy to determine the target arch expansion force that needs to be applied to achieve the target arch expansion amount.

In some embodiments of the present disclosure, the process of determining the target arch expansion amount and/or the target arch expansion force further includes steps to adjust the target arch expansion amount and/or the target arch expansion force according to one or more of the patient's age, developmental status, and type of malocclusion. For example, because the situation of age, developmental status, type of malocclusion, and so on vary widely from patient to patient, the process of determining the arch expansion amount and/or the arch expansion force needs to be adjusted for their specific conditions to meet the actual arch expansion needs.

In some embodiments of the present disclosure, the process of determining the target arch expansion amount and/or the target arch expansion force further includes steps to adjust the target arch expansion amount and/or target arch expansion force according to the loss of the arch expansion force.

The main reason for the loss of the arch expansion force is that after the arch expander is fixed to the jaw in an initial dental arch form to start the expansion, the arch expansion force exerted by the arch expander on the jaw is not constant. As the arch is gradually expanded, the arch expansion force will also gradually decrease. When the arch expansion force is not sufficient to counteract the internal anchorage force generated by the jaw tissue, that is, there is no arch expansion effect on the jaw anymore, the actual arch expansion amount may be less than the target arch expansion amount. Therefore, in determining the target arch expansion amount and/or the target arch expansion force, the attenuation of the above-mentioned arch expansion force should also be taken into account. In addition, the rate of arch expansion expression is not only related to the attenuation of the arch expansion force, but also to the patient's root length, anatomy, the biological response of the alveolar tissue to the arch expansion force, and many other factors, which need to be considered by the clinician according to the patient's age, anatomical features, developmental status, and the nature and characteristics of the arch narrowing. In some embodiments of the present disclosure, the above medical information can be taken into account in combination with the factor of arch expansion force attenuation to obtain a more reasonable compensated expansion amount and force (it should be noted that the compensation of the expansion force should be done in such a way that it does not exceed a certain upper limit in order to avoid possible damage to the dental tissues). For example, in some exemplary embodiments of the present disclosure, the compensation to the arch expansion amount can be increased by 30-50% for different parts of the jaw, depending on the specific situation of attenuation of the arch expansion force, in order to obtain a compensated target arch expansion amount.

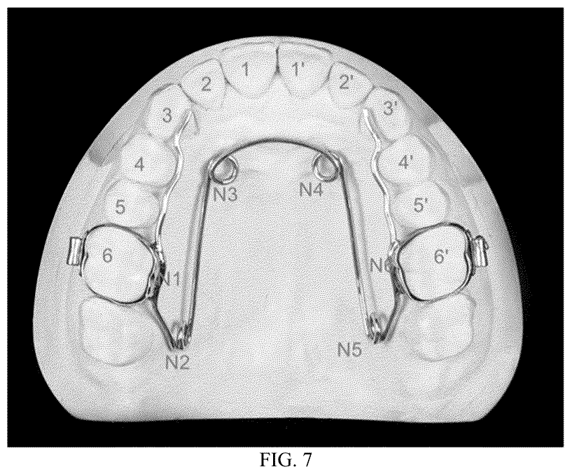

When the target arch expansion amount and the target arch expansion force have been obtained in the above steps, a digital model of a target dental jaw is further obtained in step S200, which represents a jaw in a target dental arch form. The detailed description for generating a digital model of a target dental jaw is illustrated below with reference to FIG. 5.

As shown in FIG. 5, in some exemplary embodiments of the present disclosure, a digital model 110 of an initial dental jaw (the digital model 110 of the initial dental jaw in FIG. 5 is specifically a digital model of an upper jaw) can be split by selecting a suitable dental arch splitting line L (e.g., a straight line extending along the median sagittal direction in the figure) in a cross-section of the dental arch and divided into two parts, i.e., a left part and a right part. The left and right parts are opened in translation to two sides according to the arch expansion amount obtained in the previous steps, in order to achieve the arch expansion amount of the posterior part. The semi-lateral arch is rotated with the central pit of the occlusal surface of maxillary tooth #5 as the center of the circle, until the outer ⅓ of the mesial marginal ridge of the maxillary cuspids (this is the corresponding occlusal contact point of the maxillary and mandibular cuspids on the maxillary arch) falls on the target arch curve, thus achieving an arch expansion amount in each of the anterior parts of the lower jaw and the upper jaw. For a digital model of a lower jaw, the contact point on the most buccal side of the adjacent surfaces of teeth #5 and #6 of the lower jaw is used as the center of the circle to rotate half of the lateral arch until the cusps of the cuspids on that side fall on the curve of the target arch. Finally, the gaps between the models resulting from the above translation and rotation operations are filled and shaped to obtain a digital model 120 of a target dental jaw in a target dental arch form.

Clearly, depending on the initial dental arch form, several different directions of the arch-splitting lines can be set at different locations to enable the generated digital model of the target dental jaw to fit the target dental arch form more accurately.

Furthermore, in some embodiments of the present disclosure, the method for manufacturing a pre-activated arch expander further includes steps to adjust the digital model of the target dental jaw according to the attenuation (loss) of the arch expansion force. The reasons for adjusting the digital model of the target dental jaw according to the attenuation of the arch expansion force have been described in detail in the preceding description and will not be repeated here.

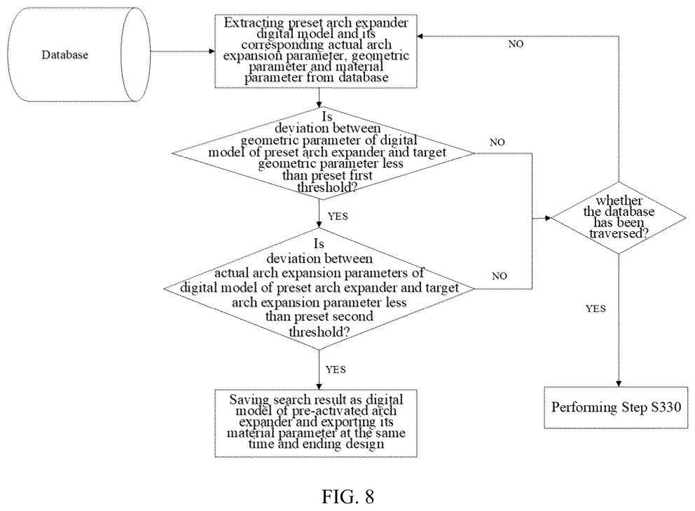

Once the target arch expansion amount and the target arch expansion force have been determined and the digital model of the target dental jaw has been generated in steps S100 to S200, the design of a digital model of a pre-activated arch expander can be carried out by step S300. FIG. 6 illustrates a specific implementation flow of step S300 according to embodiments of the present disclosure. As shown in FIG. 6, in some detailed implementations of the present embodiment, step S300 specifically includes the following steps.

S310: determining a target geometric parameter of a pre-activated arch expander based on the digital model of the target dental jaw.

S320: searching whether there is a preset digital model of an arch expander that meets a matching requirement from a database according to a target arch expansion parameter and the target geometric parameter, and if a search result is true, exporting the search result as a digital model of the pre-activated arch expander and exporting its material parameters at the same time and then ending the design, and if the search result is false, executing step S330.

S330: performing the design by using a finite element method according to the target geometric parameter and the target arch expansion parameter to obtain the digital model of the pre-activated arch expander and its material parameters that meet an arch expansion constraint condition.

Steps S310 to S330 are described in detail below.

For example, after the generation of the digital model of the target dental jaw, in step S310, the target geometric parameter of the pre-activated arch expander can be determined based on the overall form of the digital model of the target dental jaw and the shape, size, position and other characteristics of each tooth, while the material parameter of the manufacturing material can be determined in conjunction with the requirement for the target arch expansion force.

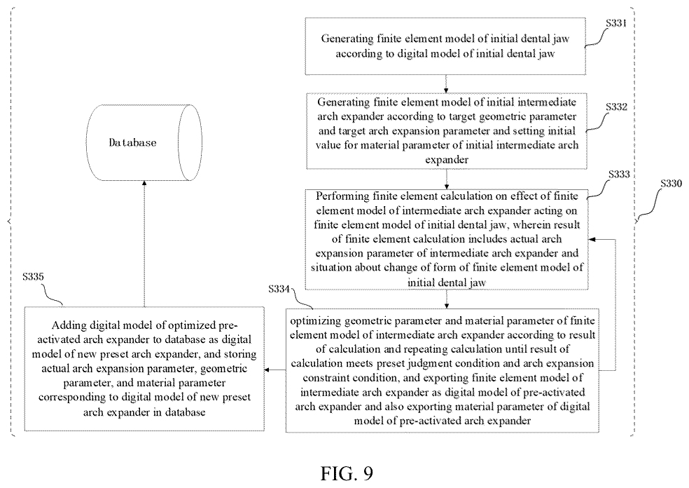

The target geometric parameter represents the geometry corresponding to the pre-activated arch expander when the jaw is adjusted from the initial dental arch form to the target dental arch form using the pre-activated arch expander. Some embodiments of the present disclosure, for example, may include one or more of the following parameters: number, shape, and fixed position of retaining band(s) (the fixed position of a retaining band can be represented by the tooth position, and the form of a retaining band can be represented by the height of the band, whether the band covers an occlusal surface, whether the band has additional occlusal pads, whether the band is connected to an adjacent band, etc.), number of spring coils contained in an arch expansion part, position, diameter, and angle of each spring coil, the curvature of an arch wire between adjacent spring coils, bending angle, length and curvature of a lingual arm contained in an arch expansion part. With the above geometric parameters determined, the key features of the geometry of the pre-activated arch expander are also determined. FIG. 7 shows a pre-activated arch expander matching the form of the target arch (as worn on a digital model of a target dental jaw), where the positions of the retaining bands and the positions of the spring coils are determined by means of calibrated key points N1-N6, respectively. Once these key points have been determined, other geometric parameters can be further determined in conjunction with the formal characteristics of the digital model of the target dental jaw.

In step S320, a digital model of an arch expander that meets the matching requirement in a plurality of digital models of pre-activated arch expanders stored in the database is retrieved according to the target arch expansion parameter and the target geometric parameter and is used as a digital model of a pre-activated arch expander, and its material parameter is extracted for subsequent manufacture of the pre-activated arch expander.

In some exemplary embodiments, the material parameter represents the property of the manufacturing material used for the pre-activated arch expander, in particular in relation to the magnitude of the arch expansion force. For example, the material parameter may include one or more of the following parameters: composition and performance of materials used for manufacturing an arch expansion part as well as the section shape and dimension of an arch wire used for manufacturing an arch expansion part. In some exemplary embodiments, the material used for the manufacture of the expansion arch part may be metal, alloys, and/or polymer capable of being used in orthodontics. Clearly, manufacturing materials of different compositions have different properties such as density, hardness, modulus of elasticity, etc. Also, the different cross-sectional forms (e.g., the cross-section of the arch wire may be rectangular, circular, or oval, etc.) and dimensions (e.g., the side length of the rectangle, the diameter of the circle, etc.) of the base structure of the expansion arch part correspond to different arch expansion forces.

In the field of orthodontic technology, as treatment cases accumulate, the database used to store case information often contains a large amount of case data on the use of arch expanders for arch expansion treatment, where data of each case may include one or more of the following information: the initial dental arch form and the target dental arch form of the jaw, the digital model of the arch expander used for treatment and its corresponding geometric parameters, material and actual arch expansion parameters (i.e., information on the arch expansion amount and the arch expansion force achieved clinically using this arch expander or obtained by finite element calculations). In the design and manufacture of pre-activated arch expanders for existing patients, if an arch expander digital model capable of achieving the same or similar arch expansion target and its corresponding material parameters can be retrieved directly from the above-mentioned database, it can be used directly in the manufacture of pre-activated arch expanders, thus significantly reducing the time for design and manufacture.

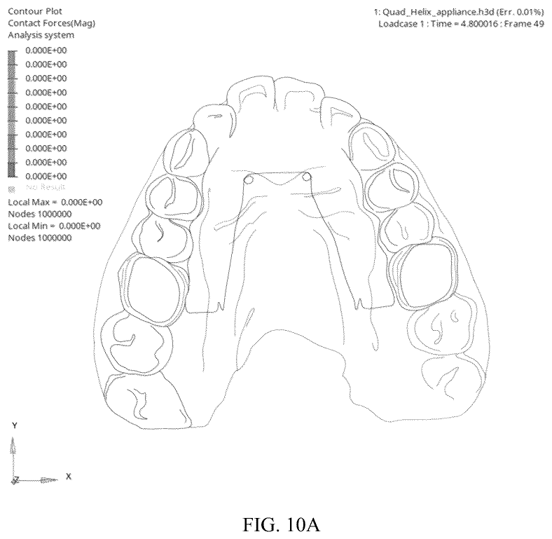

FIG. 8 shows a flow chart of step S320 according to specific implementations of the exemplary embodiments. As shown in FIG. 8, in some exemplary embodiments of the present disclosure, a search of whether there is a preset digital model of an arch expander that meets a matching requirement from a database according to a target geometric parameter and a target arch expansion parameter is conducted, and if the result of the search result is true, the result is saved as a digital model of a pre-activated arch expander and if the result of the search is false, move to step S330.

By traversing the database, it is possible to retrieve whether there is a pre-activated arch expander that meets the matching requirement. In some implementations of exemplary embodiments, as shown in FIG. 8, the matching requirement is that the deviation between the geometric parameter of the digital model of the preset arch expander and the target geometric parameter is less than a preset first threshold, and the deviation between the actual arch expansion parameter of the digital model of the preset arch expander and the target arch expansion parameter is less than a preset second threshold.

In some exemplary embodiments, in order to retrieve a digital model of a preset arch expander that matches, one or more parameters may be selected from the group consisting of number, form, and fixed position of retaining bands included in the geometric parameters, the number of spring coils included in the arch expansion part, the position, diameter, and angle of each spring coil, the curvature of the arch wire between adjacent spring coils, the angle, length, and curvature of the lingual arm included in the arch expansion part, etc., and assigned a corresponding weight according to the degree of influence on the overall form of the arch expander. Further, a weighted deviation function between the target geometric parameter and the geometric parameter of the digital model of the preset arch expander is established, and a search of whether there is a preset arch expander with a weighted deviation function smaller than a preset first threshold value is conducted throughout the database. At the same time, it is possible to conduct, in the same way, a search of whether there is a digital model of a preset arch expander whose deviation between the actual arch expansion parameter and the target arch expansion parameter is less than a preset second threshold. If there exists a digital model of a preset arch expander that satisfies both of these matching requirements, it will be directly used as a digital model of a pre-activated arch expander and its corresponding geometric and material parameters will be saved for the subsequent manufacturing process.

In some detailed implementations of exemplary embodiments, after the digital model of the pre-activated arch expander has been obtained through the above searching process, the digital model of the pre-activated arch expander can also be fine-tuned based on the digital model of the target dental jaw, for example by adjusting the shape of the retaining band to fit more closely to the teeth used for retention, or by analyzing the contact between the arch expansion part and the oral tissues and adjusting the shape of the arch expansion part to avoid excessive contact with the upper or lower jaw of the mouth based on the results of the analysis.

The above is only a schematic illustration of the use of matching requirements to retrieve a digital model of a pre-activated arch expander from a database by means of exemplary embodiments. During the specific implementations, the matching requirements can be adjusted depending on the expression of the target arch expansion parameters and the target geometric parameters. For example, in some implementations, the target arch expansion force in the target arch expansion parameters is a set of values determined by upper and lower limits, then the second threshold should be set in such a way that the actual arch expansion parameter of the pre-activated arch expander falls into the above-mentioned value range.

The rationale for the joint use of target geometric parameters and target arch expansion parameters for retrievals in the database is as follows. The target geometric parameters represent the overall formal characteristics of the pre-activated arch expander, whereas the target arch expansion parameters represent the applied forces that cause the jaw to expand and the degree of change of the expansion. For example, the overall dimensions of the jaws of an adult patient and a child patient are significantly different, and therefore the target geometric parameters are very different, whereas the target arch expansion parameters may be similar. Similarly, even if the target geometric parameters to be achieved are the same in both patients, the arch expansion amount to be achieved and the corresponding arch expansion forces to be applied will be different if the initial dental arch form of the two jaws is significantly different, i.e., the target arch expansion parameters will be very different. Therefore, retrieval of the matching arch expander digital model is not possible by target geometric parameters alone or by target arch expansion parameters alone, and a combination of these parameters is required to achieve accurate retrieval of the digital model of the pre-activated arch expander.

If a matching digital model of the pre-activated arch expander cannot be retrieved from the database in step S320, the design and optimization of the digital model of the pre-activated arch expander using the finite element method is carried out in step S330.

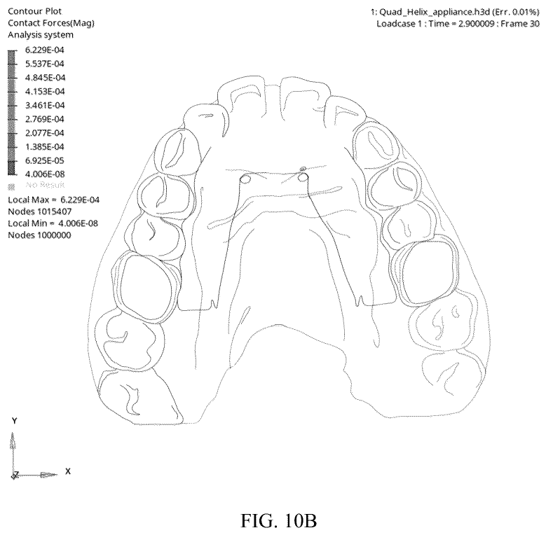

In some exemplary embodiments, in exemplary embodiments, as illustrated in a specific implementation process shown in FIG. 9, step S330 further includes the following steps.

S331: generating a finite element model of an initial dental jaw according to a digital model of an initial dental jaw.

S332: generating a finite element model of an initial intermediate arch expander according to a target geometric parameter and a target arch expansion parameter, and setting an initial value for a material parameter of the initial intermediate arch expander.

S333: performing a finite element calculation of the effect of the finite element model of the intermediate arch expander that acts on the finite element model of the initial dental jaw, where the result of the calculation includes an actual arch expansion parameter of the intermediate arch expander and a formal change of the finite element model of the initial dental jaw.

S334: optimizing a geometric parameter and a material parameter of the finite element model of the intermediate arch expander according to the result of the finite element calculation and repeating the finite element calculation until the result of the calculation meets a preset judgment condition and the result of the calculation result meets an arch expansion constraint condition, and exporting the current finite element model of the intermediate arch expander as a digital model of a pre-activated arch expander and also exporting the material parameter of the intermediate arch expander.

Steps S331 to S334 are described in detail below.

Step S331 is used to generate a finite element model of an initial dental jaw, the implementation of which has been described in step S100 regarding the generation step of the digital model of the initial dental jaw and will not be repeated here.

Step S332 generates a finite element model of an intermediate arch expander for optimization and sets an initial value. For example, the initial value can first be set with reference to the target geometric parameter such as the number, form, and fixed position of the retaining band of the intermediate arch expander, the number of spring coils included in the arch expander, the position, diameter, and angle of each spring coil, the curvature of the arch wire between adjacent spring coils, the angle, length, curvature and other parameters of the lingual arm included in the arch expansion part (i.e., the initial value of the geometric parameter of the finite element model of the intermediate arch expander is determined) to generate an initial 3D model of the intermediate arch expander, which is then meshed through a finite element method. The above meshed 3D model is then assigned a predicted material parameter as the initial value based on the target arch expansion parameter. The material parameter may include the composition and property of the material to be used for making the arch expansion part, e.g., the type, density, hardness, modulus of elasticity, Poisson's ratio, and so on of a material to be used for the arch expander. The material parameter also includes the cross-sectional shape and size of the arch wire, i.e., the cross-sectional shape and size of the arch wire can be adjusted according to the target arch expansion parameter, and the finite element model of the intermediate arch expander is finally obtained through the above steps and can be used for further optimization.

Step S333 performs a finite element calculation using the finite element model of the intermediate arch expander described above and the finite element model of the initial dental jaw to obtain the result of their interaction. Techniques for obtaining stresses and strains due to the interaction of finite element models using finite element calculation methods are well known to those skilled in the art and can be performed using established finite element simulation software. For example, the finite element model of the intermediate arch expander can be fitted to the finite element model of the initial dental jaw and the corresponding boundary condition can be set to constrain the movement between the two, and then the result of their interaction can be calculated by the finite element method. For example, the result may include the actual arch expansion parameter (including the actual arch expansion force and the actual arch expansion amount) produced by the finite element model of the intermediate arch expander acting on the finite element model of the initial dental jaw and the formal change produced by the finite element model of the initial dental jaw under the arch expansion of the finite element model of the intermediate arch expander.

For example, in some exemplary embodiments of the present disclosure, it is possible to restrict the degree of freedom of certain specific nodes on the finite element model of the intermediate arch expander, and then apply a load to the rest of the finite element model of the intermediate arch expander to cause strain on the finite element model of the intermediate arch expander. After adjusting the load application method, such as adjusting the magnitude and direction of the load applied to different parts, to deform the finite element model of the intermediate arch expander to match the finite element model of the initial dental jaw, the deformed finite element model of the intermediate arch expander is then assembled to the finite element model of the initial dental jaw. After assembling the finite element model of the intermediate arch expander to the finite element model of the initial dental jaw, the restraints on the degree of freedom of its nodes and the load applied to it are released. At this time, the actual force applied to the finite element model of the initial dental jaw by the finite element model of the intermediate arch expander can be calculated using the finite element method.

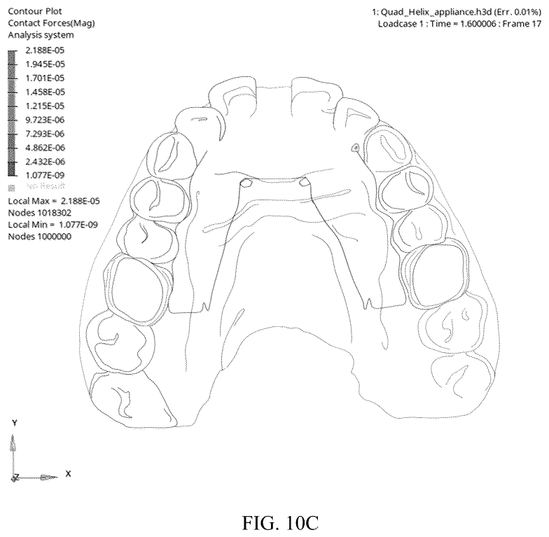

FIGS. 10A to 10C each illustrates the formal change (strain) produced by a finite element model of an initial dental jaw under the action of arch expansion during finite element calculation. As the finite element model of the initial dental jaw is continuously deformed by the arch expansion force applied by the finite element model of the intermediate arch expander, the stress and strain distributions are constantly changing during the entire calculation process. The stress and strain distribution can be updated at set intervals (e.g., every other day) and the finite element calculation can be stopped until a new mechanical equilibrium is reached between the arch expansion force provided by the finite element model of the intermediate arch expander and the resistance force generated by the periodontal tissue deformation represented by the constantly changing finite element model of the initial dental jaw. At this point, the difference between the arch form of the finite element model of the dental jaw and the initial dental arch form reflects the actual amount of expansion that can be achieved by the finite element model of the intermediate arch expander. The actual arch expansion parameter of the finite element model of the intermediate arch expander can be obtained by the distribution of the actual arch expansion force and the actual arch expansion amount obtained from the above calculation.

In some exemplary implementations of exemplary embodiments, the material parameter of the finite element model of the intermediate arch expander includes a parameter that varies with temperature. For example, by setting a material parameter (e.g., modulus of elasticity) of the finite element model of the intermediate arch expander to vary with temperature, it is possible to calculate and verify the arch expansion effect of an arch expander made from a material with shape memory effect (e.g., Ni—Ti alloy). For example, the temperature memory material has the property of recovering its initial shape within its transformation temperature range. With such property, by adjusting the temperature of the finite element model of the intermediate arch expander, the finite element model of the intermediate arch expander can be made to fit easily to the finite element model of the initial dental jaw during the assembly phase and tends to recover its initial shape after completion of the assembly, thus generating an arch expansion force on the initial dental model.

Step S334 is a step where the finite element model of the intermediate arch expander is optimized based on the finite element calculation to obtain a digital model of a pre-activated arch expander that meets the design requirement.

For example, in some exemplary implementations of exemplary embodiments, the preset judgment condition may be a limit on the range of deviation of the actual arch expansion parameter from the target arch expansion parameter achieved by the finite element model of the intermediate arch expander. That is, the actual arch expansion parameter of the finite element model of the intermediate arch expander obtained through a calculation is compared with the target arch expansion parameter expected to be achieved and if the deviation is greater than a defined range, the geometric and/or material parameter of the finite element model of the intermediate arch expander are adjusted to obtain a new finite element model of the intermediate arch expander and a new finite element calculation is performed. For example, if the actual arch expansion force or actual arch expansion amount of the finite element model of the intermediate arch expander is less than a target value, the diameter of the arch wire of the arch expander may be increased, or the position and number of turns of the spring coils may be adjusted, or the modulus of elasticity of the arch expander material may be increased, and the calculation in step S333 may be repeated using the new finite element model of the intermediate arch expander after the above adjustments to obtain a new actual arch expansion parameter and make a new comparison. The above steps may be performed several times until the deviation of the actual arch expansion parameter from the target arch expansion parameter is less than a defined range. At this point the finite element model of the intermediate arch expander is determined to be the digital model of the pre-activated arch expander and the corresponding material parameter is extracted for the subsequent manufacture of the pre-activated arch expander.

In addition, in the step of optimizing the finite element model of the intermediate arch expander, it is also necessary to consider the effect of the arch expansion constraint condition on the design of the arch expander. In some exemplary embodiments of the present disclosure, the arch expansion constraint condition includes one or more of the following conditions: constraint condition on a contact position between the finite element model of the intermediate arch expander and the finite element model of the initial dental jaw, biomechanical constraint condition on the displacement of the finite element model of the initial dental jaw under the action of the arch expansion force, and restriction condition on the root movement of the finite element model of the initial dental jaw.

For example, during the expansion of the jaw by the arch expander, if the spring coil, arch wire, and other parts of the arch expander come into contact with or even press on the oral mucosa and gum tissue, discomfort and in serious cases, even pain and inflammation may be caused to the patient. Moreover, an arch expander that is not properly designed will cause the jaw to displace too quickly under the arch expansion force, which may cause discomfort, pain, and even bone fracture. Additionally, if the position and direction that the arch expansion force applied are not set correctly, excessive tilting of a tooth towards the labial side and/or the buccal side, undesirable tilting of the root, and even the risk of bone breakage may be caused. Therefore, in the process of calculating the interaction between the finite element model of the intermediate arch expander and the finite element model of the initial dental jaw, if the result of the calculation violates the above-mentioned expansion constraint condition, the finite element model of the intermediate arch expander should be adjusted accordingly to meet the arch expansion constraint condition.

In some exemplary implementations of exemplary embodiments, as shown in FIG. 9, step S334 thereafter further includes the following step.

S335: adding the digital model of the pre-activated arch expander that is obtained after optimization to the database as a new preset digital model of an arch expander, and storing the actual arch expansion parameter, geometric parameter, and material parameter corresponding to the new preset digital model of an arch expander in the database.

The retrieval of the digital model of the pre-activated arch expander and the optimization of the finite element calculation using each of the above steps S320 and S330 have the following significant advantages over existing arch expander manufacturing methods.

By retrieving the preset digital models of the arch expander stored for historical cases in the database, the models matching the orthodontic treatment target can be retrieved quickly, thus greatly reducing the time for designing and manufacturing the pre-activated arch expanders. By using the finite element method to simulate the actual arch expansion effect of the arch expander and optimizing the finite element model of the arch expander according to the deviation from the design target, the error of the design based on manual experience in the conventional technique is reduced, and the arch expansion effect of the pre-activated arch expander is effectively enhanced.

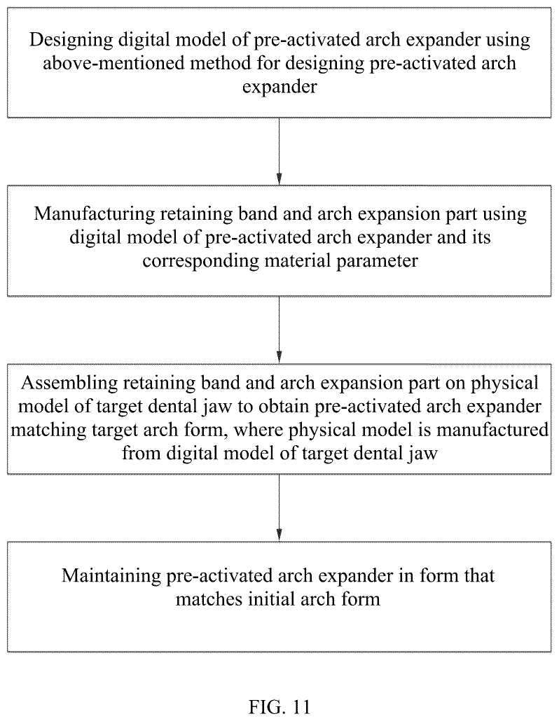

The present disclosure also provides, by way of some exemplary embodiments, a method for manufacturing a pre-activated arch expander. A flow chart of which is illustrated in FIG. 11, this method includes the following steps.

Step 1: designing a digital model of a pre-activated arch expander using the above-mentioned method for designing a pre-activated arch expander.

Step 2: manufacturing a retaining band and an arch expansion part using the digital model of the pre-activated arch expander and its corresponding material parameter.

Step 3: assembling the retaining band and the arch expansion part on a physical model of a target dental jaw to obtain a pre-activated arch expander matching a target dental arch form. The model of the target dental jaw is a physical model manufactured from the digital model of the target dental jaw.

For example, after obtaining the digital model of the pre-activated arch expander using the above-mentioned method for designing a pre-activated arch expander, the manufacturing material is selected according to a corresponding material parameter(s) of the digital model of the pre-activated arch expander, and the retaining band and the arch expansion part are manufactured using digital manufacturing techniques such as 3D printing and numerical control machine. Finally, the retaining band and the arch expansion part are assembled on the physical model of the target dental jaw by welding, bonding, or other fastening or connecting methods to obtain a pre-activated arch expander matching the target dental arch form. In this regard, the physical model of the target dental jaw may be a physical model corresponding to the digital model of the target dental jaw, which can be manufactured using manufacturing techniques such as 3D printing and a numerical control machine.

Compared to the conventional method where a technician manufactures an arch expander on an initial model before treatment according to the orthodontist's design order and then the orthodontist adjusts and activates the arch expander when clinically using the arch expander, manufacturing the arch expander on a physical model of a target dental jaw allows the arch expander to be in a pre-activated state that matches the target dental arch form upon completion of manufacture, thus effectively solving the problem in the conventional technique that the arch expansion cannot be done in only one time and constantly requires adjustment to the shape of the arch expander. In addition, by using the physical model of the target dental jaw as a reference, the geometry of the completed arch expander, in particular the geometry of the arch expansion part, is more in line with the geometric parameter determined by the design requirement, thus ensuring that the actual arch expansion effect of the pre-activated arch expander is in line with the expected arch expansion requirements. Moreover, by manufacturing the arch expansion part on the physical model of the target dental jaw, the contact between the arch expansion part and the soft tissues of the upper and lower jaws can be observed in time and adjusted accordingly, thus avoiding pain and discomfort caused by excessive contact with these parts during the use of the arch expander.

The pre-activated arch expander can be manufactured in the above steps. As the shape of the pre-activated arch expander matches the target arch expansion form, in practice the orthodontist must apply force to it to deform it until it essentially matches the patient's current arch form in order to ensure that it is fitted to the patient's jaw.

In order to improve the ease and comfort of the above-mentioned installation process, in some exemplary embodiments of the present disclosure, after completing the above steps, a fourth step is included: maintaining a pre-activated arch expander in a form that matches an initial dental arch form.

In the fourth step, by maintaining the pre-activated arch expander in a non-activated state that matches the initial dental arch form, the orthodontist can easily and quickly place the arch expander on the patient's jaw and then activate the arch expander to start the expansion operation. Therefore, the efficiency and comfort of fitting are greatly improved.

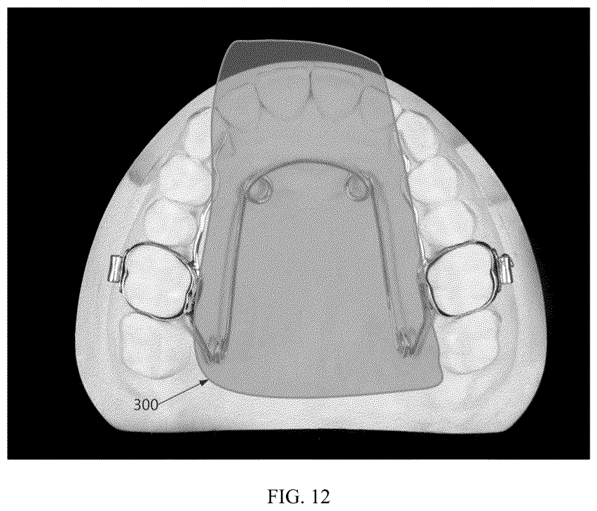

For example, in some exemplary embodiments of the present disclosure, as shown in FIG. 12, a deformation force is applied to the pre-activated arch expander to attach it to a physical model of an initial dental jaw (the physical model of the initial dental jaw is a physical model corresponding to the digital model of the initial dental jaw, which can be manufactured by techniques such as 3D printing, numerical control machine manufacturing, etc.), and then the pre-activated arch expander is maintained in a form matching the initial arch using a removable transfer template 300. In practice, the orthodontist places the aforementioned non-activated arch expander onto the patient's jaw and ensures that both of them have been securely fixed to each other before removing the transfer template 300 to return the arch expander to its pre-activated state.

The transfer template can take a variety of forms. For example, the transfer template 300 illustrated in FIG. 12 can be made by coating the side of the arch expansion part away from the jaw with a photosensitive material and then curing it with light after the coating has reached a certain thickness, which locks the arch expander into a non-activated state. In addition, the person skilled in the art can use mechanical clips, latches, interlocking clasps, wires, or any other structure that enables locking and unlocking to achieve such locking.

In some exemplary embodiments of the present disclosure, the manufacturing material of the pre-activated arch expander is a material having a shape memory effect and the human oral temperature is within the transformation temperature range of the manufacturing material. An ambient temperature condition for performing the third step above is within the transformation temperature range of the manufacturing material. The pre-activated arch expander is maintained in a form matching the initial dental arch form using the following step: mounting a pre-activated arch expander to a physical model of an initial dental jaw under an ambient temperature condition outside the transformation temperature range of the manufacturing material, to maintain pre-activated arch expander in a form that matches an initial dental arch form. The physical model of the initial dental jaw is generated based on the digital model of the initial dental jaw.

For example, an alloy material having a shape memory effect, such as a nickel-titanium alloy, can be selected as the material for the manufacture of the pre-activated arch expander. The above material has a transformation temperature range close to the temperature of the human mouth and has the property of regaining its original shape when the above material changes shape outside its transformation metamorphic temperature range and reverts to the transformation temperature range.

When manufacturing a pre-activated arch expander from the above nickel-titanium alloy material, the pre-activated arch expander can be manufactured when the ambient temperature is in the transformation temperature range of the above nickel-titanium alloy material, then the ambient temperature or the temperature of the pre-activated arch expander can be adjusted to any temperature outside the transformation temperature range (e.g., room temperature) and the pre-activated arch expander can be deformed to fit onto a physical model of an initial dental jaw. At this temperature, the pre-activated arch expander will maintain a shape that matches the initial dental arch form and does not exert an arch expansion force on the initial dental jaw.

After the manufacture of the above-mentioned pre-activated arch expander, the pre-activated arch expander can be stored at this temperature until it is clinically necessary to be attached to the patient's jaw. At this time, the pre-activated arch expander still maintains the form matching the initial dental jaw, so it can be easily attached to the patient's jaw without applying any force to deform it. After fitting, the temperature of the pre-activated arch expander gradually approaches and reaches the patient's oral temperature. As the oral temperature is within the transformation temperature range of the above-mentioned alloy material, the arch expander's expansion part will change to a form corresponding to the target dental jaw due to the memory effect, thus generating the expansion force and achieving the expansion of the jaw.

It's important to note that, the technique of using shape-memory materials for manufacturing orthodontic appliances (e.g., shell orthodontic appliances for aligning teeth using polymers having a shape-memory effect) has been disclosed in several patents, but the steps in the present disclosure for the manufacture of a pre-activated arch expander using a shape-memory material are significantly different from the conventional technique described above. The difference lies mainly in the fact that the above-mentioned shell orthodontic appliances made with the shape memory material are generally softened by placing them in hot water at the time of wear (without any special requirements for their shape after softening) to facilitate wearing onto the teeth and gradually generate orthodontic forces after the appliance has cooled down. The pre-activated arch expander of the present disclosure, on the other hand, can deform outside the transformation temperature range of the alloy material having a shape memory effect to a form that matches the initial jaw and maintains that form until the time of wear. The above specific steps are taken in the manufacture and wearing of the pre-activated arch expander of this application for the following reasons.

(1) Unlike shell orthodontic appliances for aligning teeth, which can be worn in a soft state, arch expanders, when worn, require the retaining bands to be placed on both sides more precisely to ensure the accuracy of the position and direction of the force applied. It is therefore ideal to wear the arch expander in a state that matches the initial dental arch form at the time of wear, thus ensuring that the retaining band is positioned accurately and smoothly in the correct position. Clearly, if the arch expansion part is simply softened using the shape memory material without any restrictions on its softened form after softening, as in the conventional technique, it would instead not be possible to easily position the retaining band accurately.

(2) Shell orthodontic appliances for aligning teeth, have a target form that differs only slightly (usually around 0.25 mm) from the initial form at each stage of the aligning process and therefore does not deviate significantly by being softened and then worn on the teeth. However, the amount of arch expansion to be achieved by an arch expander is much greater than the amount of tooth deflection produced by shell orthodontic appliances. If the same approach, i.e., softening the arch expansion part but not limiting its post-softening form before the expander is worn, is adopted, the geometry of the arch expansion part, such as the position of the spring coil, the curvature of the arch wire, the bending angle of the lingual arm, etc., will not be under control during the gradual restoration of the arch expansion force, which will inevitably lead to large deviations in the direction of the arch expansion force transmitted to the jaw and to a discrepancy between the arch expansion amounts of the different parts and the design values. Therefore, when the pre-activated arch expander of this application is made with a material having a shape memory effect, the specific steps described above are required to make the arch expander easy to wear while maintaining the correct application of the arch expansion force.

The present disclosure also provides, by means of some exemplary embodiments, a pre-activated arch expander, including a retaining band and an arch expansion part. The pre-activated arch expander is manufactured by the above-mentioned method for manufacturing a pre-activated arch expander. The specific construction of the above-mentioned pre-activated arch expander has been described in detail in the description of the design and the method for manufacturing a pre-activated arch expander will not be repeated here.

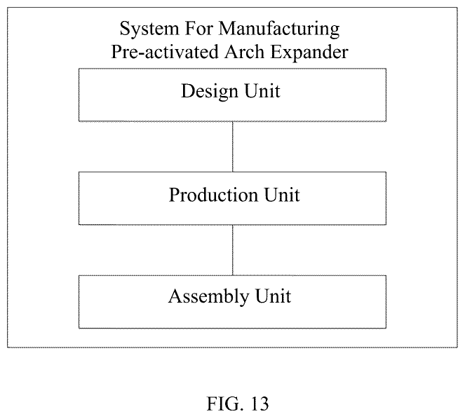

The present disclosure also provides, by means of some exemplary embodiments, a system for manufacturing a pre-activated arch expander, as shown in FIG. 13, which includes a design unit, a production unit, and an assembly unit.

The design unit is configured to design a digital model of a pre-activated arch expander using the above-mentioned method for designing a pre-activated arch expander.

The production unit is configured to manufacture a retaining band and an arch expansion part using the digital model of the pre-activated arch expander and its corresponding material parameter.

The assembly unit is configured to assemble a retaining band and an arch expansion part on a physical model of a target dental jaw to obtain a pre-activated arch expander matching a target dental arch form. The model of the target dental jaw is a physical model manufactured from the digital model of the target dental jaw.

The exemplary implementations of each of these units have been described in detail in the preceding description section of the method for manufacturing the pre-activated arch expander and will not be repeated here.

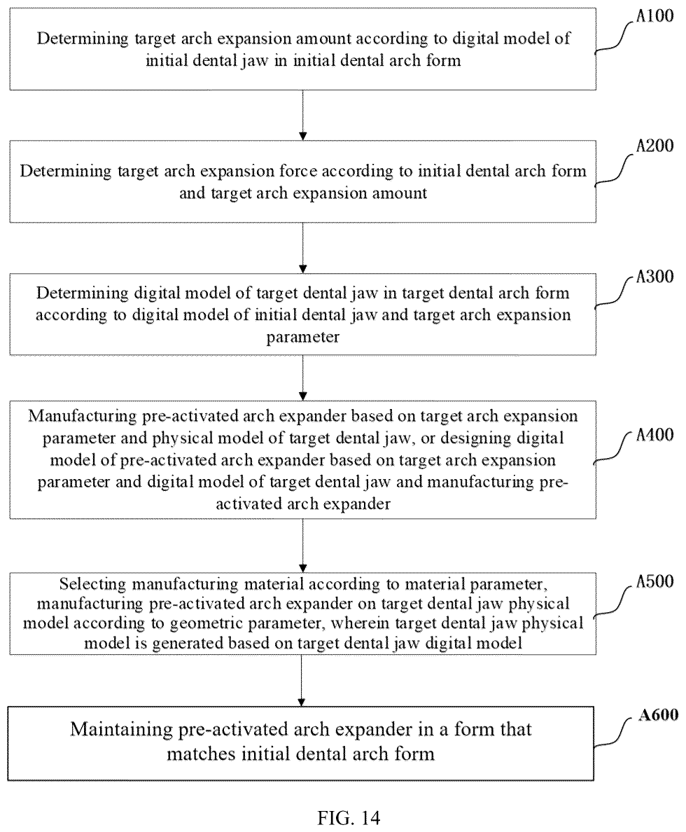

FIG. 14 illustrates a method for manufacturing a pre-activated arch expander provided by some exemplary embodiments of the present disclosure, in which the method is used to manufacture a pre-activated arch expander including a retaining band and an arch expansion part, as illustrated, the method includes the following steps.

A100: determining a target arch expansion amount according to a digital model of an initial dental jaw in an initial dental arch form.

A200: determining a target arch expansion force according to the initial dental arch form and the target arch expansion amount.

A300: determining a digital model of a target dental jaw in a target dental arch form according to a digital model of an initial dental jaw and a target arch expansion parameter.

A400: determining a geometric parameter and a material parameter of a pre-activated arch expander according to the digital model of the target dental jaw and a target arch expansion force.

A500: selecting a manufacturing material according to the material parameter, manufacturing the pre-activated arch expander on a physical model of a target dental jaw according to the geometric parameter. The physical model of the target dental jaw is generated based on the digital model of the target dental jaw.

In some exemplary embodiments, step A500 is followed by step A600: maintaining a pre-activated arch expander in a form that matches an initial dental arch form.

The exemplary implementations of each of the above steps have been described in detail in the previous section and will not be repeated here.

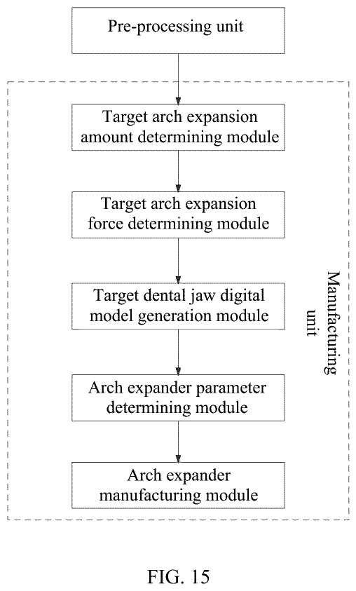

FIG. 15 illustrates a block diagram of the system structure of a pre-activated system provided by some exemplary embodiments of the present disclosure, as shown in FIG. 15, the manufacturing system includes a pre-processing unit and a manufacturing unit.

The pre-processing unit is configured to obtain information about a jaw in an initial dental arch form and generate a digital model of an initial dental jaw.

The manufacturing unit is configured to manufacture a pre-activated arch expander using the above-mentioned method for manufacturing the pre-activated arch expander.

For example, in some exemplary embodiments of the present disclosure, the pre-processing unit acquires a digital 3D model of teeth, periodontal tissue, and alveolar bone by means of optical scanning, X-ray/ultrasound imaging, CT scanning or MM, and further processes the digital 3D model of each of these tissue parts by operations such as denoising, cavity filling, and registration, so as to obtain a digital model of an initial dental jaw.

In some exemplary embodiments, as shown in FIG. 15, the manufacturing unit further includes a target-arch-expansion-amount determination module, a target-arch-expansion-force determination module, a target-dental-jaw-digital-model generation module, an arch-expander-parameter determination module, and an arch expander manufacturing module.

The target-arch-expansion-amount determination module is configured to determine a target arch expansion amount according to a digital model of an initial dental jaw in an initial dental arch form.

The target-arch-expansion-force determination module is configured to determine a target arch expansion force according to an initial dental arch form and the target arch expansion amount.

The target-dental-jaw-digital-model generation module is configured to determine a digital model of a target dental jaw in a target dental arch form according to the digital model of the initial dental jaw and a target arch expansion parameter.

The arch-expander-parameter determination module is configured to determine a geometric parameter and a material parameter of a pre-activated arch expander according to the digital model of the target dental jaw and a target arch expansion force.

The arch expander manufacturing module is configured to select a manufacturing material according to the material parameter and manufacture a pre-activated arch expander on a physical model of a target dental jaw according to the geometric parameter. The physical model of the target dental jaw is generated based on the digital model of the target dental jaw.

The above has been described in detail with respect to the detailed descriptions of the present disclosure. It will be apparent to those skilled in the art that various modifications and adaptations may be made to the present disclosure without departing from the principles of the present disclosure, which are also intended to be within the scope of the appended claims.

What is claimed is:

1. A method for designing a pre-activated arch expander, comprising:
determining a target arch expansion parameter according to a digital model of an initial dental jaw in an initial dental arch form, wherein the target arch expansion parameter includes a target arch expansion amount and a target arch expansion force;
determining a digital model of a target dental jaw in a target dental arch form according to the digital model of the initial dental jaw and the target arch expansion parameter; and
designing a digital model of a pre-activated arch expander based on the target arch expansion parameter and the digital model of the target dental jaw, wherein the pre-activated arch expander includes a retaining band and an arch expansion part.

2. The method according to claim 1, wherein the target arch expansion amount includes one or more of the following parameters corresponding to an adjustment of a jaw from the initial dental arch form to the target dental arch form:
the amount of dental arch expansion of the whole of an upper jaw, the amount of dental arch expansion of one side of the upper jaw, the amount of dental arch expansion of the anterior region of the upper jaw, the amount of the dental arch expansion of a posterior region of the upper jaw, the amount of dental arch expansion of the whole of a lower jaw, the amount of dental arch expansion of one side of the lower jaw, the amount of dental arch expansion of the anterior region of the lower jaw, and the amount of the dental arch expansion of a posterior region of the lower jaw.

3. The method according to claim 1, wherein the target arch expansion amount is determined by the difference between the widths of the initial dental arch form and the target dental arch forma at a corresponding position.

4. The method according to claim 3, wherein the difference between the widths of the initial dental arch form and the target dental arch forma at a corresponding position is determined based on measurement of the digital model of the initial dental jaw and analysis of the arch form of the digital model of the initial dental jaw.

5. The method according to claim 1, wherein the target arch expansion force includes the value and the direction of an arch expansion force acting on each tooth of a jaw for adjusting the jaw from the initial dental arch form to the target dental arch form.

6. The method according to claim 1, further comprising:
adjusting at least one of the target arch expansion amount or the target arch expansion force according to the loss of an arch expansion force.

7. The method according to claim 1, wherein the step of designing a digital model of a pre-activated arch expander based on the target arch expansion parameter and the digital model of the target dental jaw further includes:
determining a target geometric parameter of the pre-activated arch expander based on the digital model of the target dental jaw;
searching whether there is a digital model of a preset arch expander that meets a matching requirement from a database according to the target arch expansion parameter and the target geometric parameter; and
determining whether a result of the searching is true or false,
upon determining that the result of the searching is true: exporting the result of the searching as the digital model of the pre-activated arch expander, exporting a material parameter of the digital model of the pre-activated arch expander at the same time, and ending the step of designing a digital model of a pre-activated arch expander, and
upon determining that the result of the searching is false: designing the digital model of the pre-activated arch expander by using a finite element method according to the target geometric parameter and the target arch expansion parameter, and obtaining the digital model of the pre-activated arch expander that meets an arch expansion constraint condition and a material parameter of the digital model of the pre-activated arch expander.

8. The method according to claim 7, wherein the target geometric parameter includes one or more of the following parameters:
number, shape, and fixed position of one or more retaining bands;
number of one or more spring coils contained in the arch expansion part;
position, diameter, and angle of each spring coil;
curvature of an arch wire between adjacent spring coils; and
bending angle, length, and curvature of a lingual arm contained in the arch expansion part.

9. The method according to claim 7, wherein the material parameter includes one or more of the following parameters:
composition and performance of a material used for manufacturing the arch expansion part; and
shape and dimension of a cross-section of an arch wire used for manufacturing the arch expansion part.

10. The method according to claim 7, wherein the material parameter includes a parameter representing that the performance of the material varies with temperature.

11. The method according to claim 7, wherein the matching requirement includes:
the deviation between a geometric parameter of the digital model of the preset arch expander and the target geometric parameter is less than a preset first threshold, and
the deviation between an actual arch expansion parameter of the digital model of the preset arch expander and the target arch expansion parameter is less than a preset second threshold.

12. The method according to claim 7, wherein, the step of designing the digital model of the pre-activated arch expander by using a finite element method according to the target geometric parameter and the target arch expansion parameter and obtaining the digital model of the pre-activated arch expander that meets an arch expansion constraint condition and a material parameter of the digital model of the pre-activated arch expander includes the following steps:
generating a finite element model of the initial dental jaw according to the digital model of the initial dental jaw;
generating a finite element model of an initial intermediate arch expander according to the target geometric parameter and the target arch expansion parameter, and setting an initial value for a material parameter of the initial intermediate arch expander;
performing a finite element calculation on the effect of the finite element model of the intermediate arch expander acting on the finite element model of the initial dental jaw, wherein a result of the finite element calculation includes an actual arch expansion parameter of the intermediate arch expander and a situation about the change of the form of the finite element model of the initial dental jaw; and
optimizing the geometric parameter and the material parameter of the finite element model of the intermediate arch expander according to the result of the calculation and repeating the calculation until the result of the calculation meets a preset judgment condition and the arch expansion constraint condition, and exporting the finite element model of the intermediate arch expander as the digital model of the pre-activated arch expander and also exporting a material parameter of the digital model of the pre-activated arch expander.

13. The method according to claim 12, wherein the arch expansion constraint condition includes one or more of the following conditions:
a constraint condition on a contact position between the finite element model of the intermediate arch expander and the finite element model of the initial dental jaw;
a biomechanical constraint condition on the displacement of the finite element model of the initial dental jaw under the action of the arch expansion force; and
a restriction condition on a tooth root movement of the finite element model of the initial dental jaw.

14. The method according to claim 12, wherein the step of designing the digital model of the pre-activated arch expander by using a finite element method according to the target geometric parameter and the target arch expansion parameter and obtaining the digital model of the pre-activated arch expander that meets an arch expansion constraint condition and a material parameter of the digital model of the pre-activated arch expander further includes:
after the step of optimizing the geometric parameter and the material parameter, adding a digital model of the optimized pre-activated arch expander to the database as a digital model of a new preset arch expander, and storing an actual arch expansion parameter, a geometric parameter, and a material parameter corresponding to the digital model of the new preset arch expander in the database.

15. A method for manufacturing a pre-activated arch expander, comprising:
designing a digital model of a pre-activated arch expander;
manufacturing a retaining band and an arch expansion part using the digital model of the pre-activated arch expander and its corresponding material parameter; and
assembling the retaining band and the arch expansion part on a physical model of a target dental jaw to obtain a pre-activated arch expander matching a target dental arch form, wherein the physical model of the target dental jaw is manufactured from a digital model of the target dental jaw,
wherein designing a digital model of a pre-activated arch expander includes:
determining a target arch expansion parameter according to a digital model of an initial dental jaw in an initial dental arch form, wherein the target arch expansion parameter includes a target arch expansion amount and a target arch expansion force;
determining a digital model of a target dental jaw in a target dental arch form according to the digital model of the initial dental jaw and the target arch expansion parameter; and
designing a digital model of a pre-activated arch expander based on the target arch expansion parameter and the digital model of the target dental jaw, wherein the pre-activated arch expander includes a retaining band and an arch expansion part.

16. The method according to claim 15, wherein after the step of assembling the retaining band and the arch expansion part on a physical model of a target dental jaw to obtain a pre-activated arch expander matching a target dental arch form, the method further comprises:
maintaining the pre-activated arch expander in a form that matches an initial dental arch form.

17. The method according to claim 16, wherein the step of maintaining the pre-activated arch expander in a form that matches an initial dental arch form includes:
applying a deforming force to the pre-activated arch expander while mounting the pre-activated arch expander to a physical model of an initial dental jaw, wherein the physical model of the initial dental jaw is generated based on a digital model of the initial dental jaw; and
maintaining the pre-activated arch expander in a form that matches the initial dental arch form using a removable transfer template.

18. The method according to claim 16, wherein:
a manufacturing material of the pre-activated arch expander is a material having a shape memory effect and an oral temperature of a human is within a transformation temperature range of the manufacturing material;
an ambient temperature condition for the manufacture and the assembly of the pre-activated arch expander is within the transformation temperature range of the manufacturing material; and
the step of maintaining the pre-activated arch expander in a form that matches an initial dental arch form includes: under the ambient temperature condition outside the transformation temperature range of the manufacturing material, mounting the pre-activated arch expander to a physical model of an initial dental jaw to maintain the pre-activated arch expander in a form that matches the initial dental arch form, wherein the physical model of the initial dental jaw is generated based on a digital model of the initial dental jaw.

19. A pre-activated arch expander, comprising:
a retaining band; and
an arch expansion part,
wherein the pre-activated arch expander is manufactured using a method for manufacturing a pre-activated arch expander, and the method includes:
designing a digital model of a pre-activated arch expander;
manufacturing a retaining band and an arch expansion part using the digital model of the pre-activated arch expander and its corresponding material parameter; and
assembling the retaining band and the arch expansion part on a physical model of a target dental jaw to obtain a pre-activated arch expander matching a target dental arch form, wherein the physical model of the target dental jaw is manufactured from a digital model of the target dental jaw,
wherein designing a digital model of a pre-activated arch expander includes:
determining a target arch expansion parameter according to a digital model of an initial dental jaw in an initial dental arch form, wherein the target arch expansion parameter includes a target arch expansion amount and a target arch expansion force;
determining a digital model of a target dental jaw in a target dental arch form according to the digital model of the initial dental jaw and the target arch expansion parameter; and
designing a digital model of a pre-activated arch expander based on the target arch expansion parameter and the digital model of the target dental jaw, wherein the pre-activated arch expander includes a retaining band and an arch expansion part.

20. A system for manufacturing a pre-activated arch expander, comprising:
a design unit configured to design a digital model of a pre-activated arch expander using a method for designing a pre-activated arch expander, wherein the method includes:
determining a target arch expansion parameter according to a digital model of an initial dental jaw in an initial dental arch form, wherein the target arch expansion parameter includes a target arch expansion amount and a target arch expansion force;
determining a digital model of a target dental jaw in a target dental arch form according to the digital model of the initial dental jaw and the target arch expansion parameter; and
designing a digital model of a pre-activated arch expander based on the target arch expansion parameter and the digital model of the target dental jaw, wherein the pre-activated arch expander includes a retaining band and an arch expansion part;
a production unit configured to manufacture a retaining band and an arch expansion part using the digital model of the pre-activated arch expander and its corresponding material parameter; and
an assembly unit configured to assemble the retaining band and the arch expansion part on a physical model of a target dental jaw to obtain the pre-activated arch expander matching a target dental arch form, wherein the physical model of the target dental jaw is manufactured based on the digital model of the target dental jaw.

21. A method for manufacturing a pre-activated arch expander, comprising:
determining a target arch expansion amount according to a digital model of an initial dental jaw in an initial dental arch form;
determining a target arch expansion force according to the initial dental arch form and the target arch expansion amount;
determining a digital model of a target dental jaw in a target dental arch form according to the digital model of the initial dental jaw and a target arch expansion parameter;
determining a geometric parameter and a material parameter of a pre-activated arch expander according to the digital model of the target dental jaw and the target arch expansion force, wherein the pre-activated arch expander includes a retaining band and an arch expansion part; and
selecting a manufacturing material according to the material parameter, manufacturing the pre-activated arch expander on a physical model of the target dental jaw according to the geometric parameter, wherein the physical model of the target dental jaw is generated based on the digital model of the target dental jaw.

22. The method according to claim 21, wherein the target arch expansion amount includes one or more of the following parameters corresponding to an adjustment of a jaw from the initial dental arch form to the target dental arch form: the amount of dental arch expansion of the whole of an upper jaw, the amount of dental arch expansion of one side of the upper jaw, the amount of dental arch expansion of the anterior region of the upper jaw, the amount of the dental arch expansion of a posterior region of the upper jaw, the amount of dental arch expansion of the whole of a lower jaw, the amount of dental arch expansion of one side of the lower jaw, the amount of dental arch expansion of the anterior region of the lower jaw, and the amount of the dental arch expansion of a posterior region of the lower jaw.

23. The method according to claim 21, wherein the target arch expansion amount is determined by the difference between the widths of the initial dental arch form and the target dental arch forma at a corresponding position.

24. The method according to claim 23, wherein the difference between the widths of the initial dental arch form and the target dental arch forma at a corresponding position is determined based on measurement of the digital model of the initial dental jaw and analysis of the arch form of the digital model of the initial dental jaw.

25. The method according to claim 21, wherein the target arch expansion force includes the range and the direction of an arch expansion force acting on each tooth of a jaw for adjusting the jaw from the initial dental arch form to the target dental arch form.

26. The method according to claim 1, wherein the target arch expansion force is determined based on the initial dental arch form and the target arch expansion amount according to the principle of oral orthodontic mechanics.

27. The method according to claim 21, wherein the target arch expansion force is determined by retrieving a similar historical case from a database to obtain a corresponding treatment regimen and determined based on the initial dental arch form and the target arch expansion amount.

28. The method according to claim 21, wherein the target arch expansion force is determined based on a relationship between an arch expansion amount and an arch expansion force, wherein the relationship is obtained statistically from an experimental measurement and/or a clinical treatment result.

29. The method according to claim 21, further comprising:
adjusting the target arch expansion amount and/or the target arch expansion force according to one or more of a patient's age, developmental status, and type of malocclusion.

30. The method according to claim 21, further comprising:
adjusting the target arch expansion amount and/or the target arch expansion force according to the loss of an arch expansion force.

31. The method according to claim 21, further comprising:
adjusting the digital model of the target dental jaw according to the loss of an arch expansion force.

32. The method according to claim 21, wherein the geometric parameter includes one or more of the following parameters:
number, shape, and fixed position of one or more retaining bands;
number of one or more spring coils contained in the arch expansion part;
position, diameter, and angle of each spring coil;
curvature of an arch wire between adjacent spring coils; and
bending angle, length, and curvature of a lingual arm contained in the arch expansion part.

33. The method according to claim 21, wherein the material parameter includes one or more of the following parameters:
composition and performance of a material used for manufacturing the arch expansion part; and
shape and dimension of a cross-section of an arch wire used for manufacturing the arch expansion part.

34. The method according to claim 21, further comprising:
after the step of selecting a manufacturing material according to the material parameter and manufacturing the pre-activated arch expander on a physical model of the target dental jaw according to the geometric parameter, maintaining the pre-activated arch expander in a form that matches the initial dental arch form.

35. The method according to claim 34, wherein the step of maintaining the pre-activated arch expander in a form that matches the initial dental arch form further includes:
applying a deforming force to the pre-activated arch expander while mounting the pre-activated arch expander to a physical model of an initial dental jaw, wherein the physical model of the initial dental jaw is generated based on the digital model of the initial dental jaw; and
maintaining the pre-activated arch expander in a form that matches the initial dental arch form using a removable transfer template.

36. The method according to claim 34, wherein:
a manufacturing material of the pre-activated arch expander is a material having a shape memory effect and an oral temperature of a human is within a transformation temperature range of the manufacturing material;
an ambient temperature condition for performing the step of selecting a manufacturing material according to the material parameter and manufacturing the pre-activated arch expander on the physical model of the target dental jaw according to the geometric parameter is within the transformation temperature range of the manufacturing material; and
the step of maintaining the pre-activated arch expander in a form that matches an initial dental arch form includes: under the ambient temperature condition outside the transformation temperature range of the manufacturing material, mounting the pre-activated arch expander to a physical model of an initial dental jaw to maintain the pre-activated arch expander in a form that matches the initial dental arch form, wherein the physical model of the initial dental jaw is generated based on a digital model of the initial dental jaw.

37. A system for manufacturing a pre-activated arch expander, comprising:
a pre-processing unit configured to obtain information about a jaw in an initial dental arch form and generate a digital model of an initial dental jaw; and
a manufacturing unit configured to manufacture a pre-activated arch expander using a method for manufacturing a pre-activated arch expander, wherein the method includes:
determining a target arch expansion amount according to a digital model of an initial dental jaw in an initial dental arch form;
determining a target arch expansion force according to the initial dental arch form and the target arch expansion amount;
determining a digital model of a target dental jaw in a target dental arch form according to the digital model of the initial dental jaw and a target arch expansion parameter;
determining a geometric parameter and a material parameter of a pre-activated arch expander according to the digital model of the target dental jaw and the target arch expansion force, wherein the pre-activated arch expander includes a retaining band and an arch expansion part; and
selecting a manufacturing material according to the material parameter, manufacturing the pre-activated arch expander on a physical model of the target dental jaw according to the geometric parameter, wherein the physical model of the target dental jaw is generated based on the digital model of the target dental jaw.

38. A pre-activated arch expander, including a retaining band and an arch expansion part, wherein the pre-activated arch expander is manufactured using a method for manufacturing a pre-activated arch expander, wherein the method includes:
determining a target arch expansion amount according to a digital model of an initial dental jaw in an initial dental arch form;
determining a target arch expansion force according to the initial dental arch form and the target arch expansion amount;
determining a digital model of a target dental jaw in a target dental arch form according to the digital model of the initial dental jaw and a target arch expansion parameter;
determining a geometric parameter and a material parameter of a pre-activated arch expander according to the digital model of the target dental jaw and the target arch expansion force, wherein the pre-activated arch expander includes a retaining band and an arch expansion part; and
selecting a manufacturing material according to the material parameter, manufacturing the pre-activated arch expander on a physical model of the target dental jaw according to the geometric parameter, wherein the physical model of the target dental jaw is generated based on the digital model of the target dental jaw.
